(19) United States
(12) Patent Application Publication
(10) Pub. No.: US 2025/0132804 A1
(43) Pub. Date: Apr. 24, 2025

(54) CONFIGURING A CODEBOOK CORRESPONDING TO TRANSMIT PRECODING MATRIX INFORMATION

(71) Applicant: Lenovo (Singapore) Pte. Ltd., New Tech Park (SG)

(72) Inventors: Ahmed Hindy, Aurora, IL (US); Vijay Nangia, Woodridge, IL (US)

(21) Appl. No.: 18/688,224

(22) PCT Filed: Aug. 11, 2022
(86) PCT No.: PCT/IB2022/057487

§ 371 Date: Feb. 29, 2024

Related U.S. Application Data
(60) Provisional application No. 63/238,731, filed on Aug. 30, 2021.

(51) Int. Cl. H04B 7/06; H04W 72/1268; H04W 72/232

(52) U.S. Cl. CPC H04B 7/0639; H04W 72/1268; H04W 72/232

(57) ABSTRACT

Apparatuses, methods, and systems are disclosed for configuring a codebook corresponding to TPMI. One method includes receiving a codebook configuration from a network. The codebook configuration corresponds to an enhanced UL codebook-based transmission, the codebook corresponds to a TPMI, the TPMI corresponds to uplink transmission, and the TPMI corresponds to at least one layer. The method includes transmitting a set of SRSs. The method includes receiving the TPMI via a DCI for scheduling a PUSCH transmission. The DCI is received on a PDCCH, a PDSCH, or a combination thereof, and the DCI is decomposed into a first stage DCI and a second stage DCI. The method includes receiving a subset of codebook parameters corresponding to the TPMI in a second stage DCI. The second stage DCI is received in the PDCCH, the PDSCH, or a combination thereof.

### CROSS-REFERENCE TO RELATED APPLICATIONS

This application claims priority to U.S. Patent Application Ser. No. 63/238,731 entitled “APPARATUSES, METHODS, AND SYSTEMS FOR HIGH-RESOLUTION CSI FEEDBACK FOR UPLINK TRANSMISSIONS” and filed on Aug. 30, 2021 for Ahmed Hindy et al., which is incorporated herein by reference in its entirety.

### FIELD

The subject matter disclosed herein relates generally to wireless communications and more particularly relates to configuring a codebook corresponding to transmit precoding matrix information (“TPMI”).

### BACKGROUND

In certain wireless communications networks, channel state information (“CSI”) reporting and codebook structures may be used for uplink (“UL”) transmission. In such networks, the CSI reporting and codebook structures may not be efficient.

### BRIEF SUMMARY

Methods for configuring a codebook corresponding to TPMI are disclosed. Apparatuses and systems also perform the functions of the methods. One embodiment of a method includes receiving, at a user equipment (“UE”), a codebook configuration from a network. The codebook configuration corresponds to an enhanced UL codebook-based transmission, the codebook corresponds to a TPMI, the TPMI corresponds to uplink transmission, and the TPMI corresponds to at least one layer. In some embodiments, the method includes transmitting a set of sounding reference signals (“SRSs”). In certain embodiments, the method includes receiving the TPMI via a downlink control information (“DCI”) for scheduling a physical uplink shared channel (“PUSCH”) transmission. The DCI is received on a physical downlink control channel (“PDCCH”), a physical downlink shared channel (“PDSCH”), or a combination thereof, and the DCI is decomposed into a first stage DCI and a second stage DCI. In various embodiments, the method includes receiving a subset of codebook parameters corresponding to the TPMI in a second stage DCI. The second stage DCI is received in the PDCCH, the PDSCH, or a combination thereof.

One apparatus for configuring a codebook corresponding to TPMI a receiver to receive a codebook configuration from a network. The codebook configuration corresponds to an enhanced UL codebook-based transmission, the codebook corresponds to a TPMI, the TPMI corresponds to uplink transmission, and the TPMI corresponds to at least one layer. In some embodiments, the apparatus includes a transmitter to transmit a set of SRSs. The receiver further to: receive the TPMI via a DCI for scheduling a PUSCH transmission, wherein the DCI is received on a PDCCH, a PDSCH, or a combination thereof, and the DCI is decomposed into a first stage DCI and a second stage DCI; and receive a subset of codebook parameters corresponding to the TPMI in a second stage DCI. The second stage DCI is received in the PDCCH, the PDSCH, or a combination thereof.

Another embodiment of a method for configuring a codebook corresponding to TPMI includes transmitting, at a network device, a codebook configuration from a network. The codebook configuration corresponds to an enhanced UL codebook-based transmission, the codebook corresponds to a TPMI, the TPMI corresponds to uplink transmission, and the TPMI corresponds to at least one layer. In some embodiments, the method includes receiving a set of SRSs. In certain embodiments, the method includes transmitting the TPMI via a DCI for scheduling a PUSCH transmission. The DCI is transmitted on a PDCCH, a PDSCH, or a combination thereof, and the DCI is decomposed into a first stage DCI and a second stage DCI. In various embodiments, the method includes transmitting a subset of codebook parameters corresponding to the TPMI in a second stage DCI. The second stage DCI is transmitted in the PDCCH, the PDSCH, or a combination thereof.

Another apparatus for configuring a codebook corresponding to TPMI includes a transmitter to transmit a codebook configuration from a network. The codebook configuration corresponds to an enhanced UL codebook-based transmission, the codebook corresponds to a TPMI, the TPMI corresponds to uplink transmission, and the TPMI corresponds to at least one layer. In some embodiments, the apparatus includes a receiver to receive a set of SRSs. The transmitter further to: transmit the TPMI via a DCI for scheduling a PUSCH transmission, wherein the DCI is transmitted on a PDCCH, a PDSCH, or a combination thereof, and the DCI is decomposed into a first stage DCI and a second stage DCI; and transmit a subset of codebook parameters corresponding to the TPMI in a second stage DCI. The second stage DCI is transmitted in the PDCCH, the PDSCH, or a combination thereof.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for configuring a codebook corresponding to TPMI;

FIG. 2 is a schematic block diagram illustrating one embodiment of an apparatus that may be used for configuring a codebook corresponding to TPMI;

FIG. 3 is a schematic block diagram illustrating one embodiment of an apparatus that may be used for configuring a codebook corresponding to TPMI;

FIGS. 4A through 4C are block diagrams illustrating one embodiment of ASN.1 code in a PUSCH-Config IE;

FIGS. 5A through 5C are block diagrams illustrating another embodiment of ASN.1 code in a PUSCH-Config IE;

FIG. 6 is a flow chart diagram illustrating one embodiment of a method for configuring a codebook corresponding to TPMI; and

FIG. 7 is a flow chart diagram illustrating another embodiment of a method for configuring a codebook corresponding to TPMI.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures Like numbers refer to like elements in all figures, including alternate embodiments of like elements.

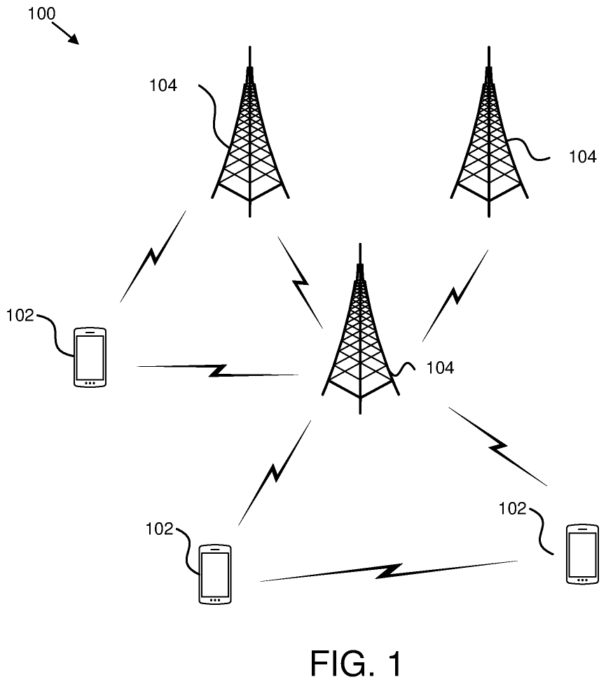

FIG. 1 depicts an embodiment of a wireless communication system 100 for configuring a codebook corresponding to TPMI. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the UL using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive a codebook configuration from a network. The codebook configuration corresponds to an enhanced UL codebook-based transmission, the codebook corresponds to a TPMI, the TPMI corresponds to uplink transmission, and the TPMI corresponds to at least one layer. In some embodiments, the remote unit 102 may transmit a set of SRSs. In certain embodiments, the remote unit 102 may receive the TPMI via a DCI for scheduling a PUSCH transmission. The DCI is received on a PDCCH, a PDSCH, or a combination thereof, and the DCI is decomposed into a first stage DCI and a second stage DCI. In various embodiments, the remote unit 102 may receive a subset of codebook parameters corresponding to the TPMI in a second stage DCI. The second stage DCI is received in the PDCCH, the PDSCH, or a combination thereof. Accordingly, the remote unit 102 may be used for configuring a codebook corresponding to TPMI.

In certain embodiments, a network unit 104 may transmit a codebook configuration from a network. The codebook configuration corresponds to an enhanced UL codebook-based transmission, the codebook corresponds to a TPMI, the TPMI corresponds to uplink transmission, and the TPMI corresponds to at least one layer. In some embodiments, the network unit 104 may receive a set of SRSs. In certain embodiments, the network unit 104 may transmit the TPMI via a DCI for scheduling a PUSCH transmission. The DCI is transmitted on a PDCCH, a PDSCH, or a combination thereof, and the DCI is decomposed into a first stage DCI and a second stage DCI. In various embodiments, the network unit 104 may transmit a subset of codebook parameters corresponding to the TPMI in a second stage DCI. The second stage DCI is transmitted in the PDCCH, the PDSCH, or a combination thereof. Accordingly, the network unit 104 may be used for configuring a codebook corresponding to TPMI.

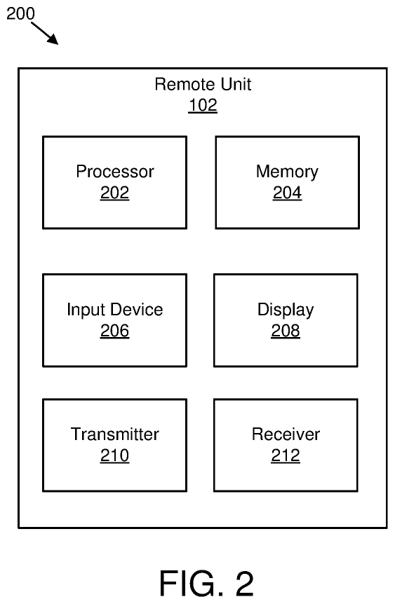

FIG. 2 depicts one embodiment of an apparatus 200 that may be used for configuring a codebook corresponding to TPMI. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the receiver 212 to receive a codebook configuration from a network. The codebook configuration corresponds to an enhanced UL codebook-based transmission, the codebook corresponds to a TPMI, the TPMI corresponds to uplink transmission, and the TPMI corresponds to at least one layer. In some embodiments, the transmitter 210 to transmit a set of SRSs. The receiver 212 further to: receive the TPMI via a DCI for scheduling a PUSCH transmission, wherein the DCI is received on a PDCCH, a PDSCH, or a combination thereof, and the DCI is decomposed into a first stage DCI and a second stage DCI; and receive a subset of codebook parameters corresponding to the TPMI in a second stage DCI. The second stage DCI is received in the PDCCH, the PDSCH, or a combination thereof.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

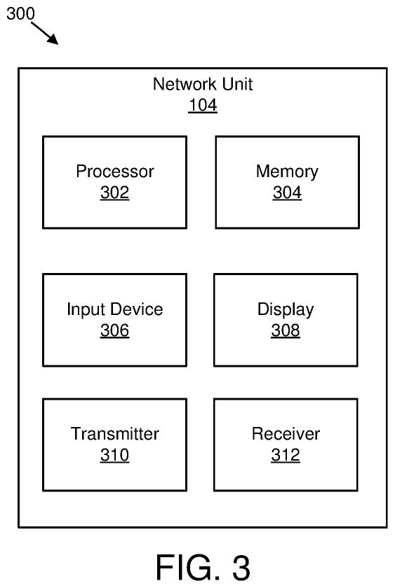

FIG. 3 depicts one embodiment of an apparatus 300 that may be used for configuring a codebook corresponding to TPMI. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In some embodiments, the transmitter 310 to transmit a codebook configuration from a network. The codebook configuration corresponds to an enhanced UL codebook-based transmission, the codebook corresponds to a TPMI, the TPMI corresponds to uplink transmission, and the TPMI corresponds to at least one layer. In some embodiments, the receiver 312 to receive a set of SRSs. The transmitter 310 further to: transmit the TPMI via a DCI for scheduling a PUSCH transmission, wherein the DCI is transmitted on a PDCCH, a PDSCH, or a combination thereof, and the DCI is decomposed into a first stage DCI and a second stage DCI; and transmit a subset of codebook parameters corresponding to the TPMI in a second stage DCI. The second stage DCI is transmitted in the PDCCH, the PDSCH, or a combination thereof.

It should be noted that one or more embodiments described herein may be combined into a single embodiment.

In certain embodiments, such as for new radio (“NR”), CSI feedback (or signaling and/or an indication) for UL transmission may be limited. In such embodiments, two configurations may be supported for UL CSI (e.g., codebook-based and non-codebook based). Codebook-based CSI, in which the network selects a codebook from a set of pre-defined codebooks for UL transmission, and wherein each codebook is characterized by a transmission rank, an antenna coherence assumption, and a specific combination and/or selection of antenna ports per transmission layer. On the other hand, non-codebook-based CSI is transparent in the sense that the UE transmits a specific group of beamformed SRSs (e.g., beams) using one or more SRS resources, and the network selects a subset of the SRSs within the group that corresponds to the best beams and indicates them to the UE via an SRS resource indicator (“SRI”). An UL CSI framework may use a very limited number of bits for precoder information at the expense of performance, compared with DL CSI framework in which CSI fed back from the UE via uplink control information (“UCI”) may be very large (e.g., >1000 bits at a large bandwidth), thus, the UL CSI framework may provide significantly better performance. In some embodiments, a new class of UL CSI may improve UL transmission throughput with reasonable CSI feedback overhead.

In various embodiments, efficient CSI reporting or signaling and/or indication and codebook structures for UL transmission may be used with an aim to optimize a tradeoff between UL codebook performance and corresponding CSI feedback overhead. In certain embodiments, there may be means of indicating a codebook framework. In some embodiments, details of a precoder structure on which UL codebook is based upon may be provided. In various embodiments, there may be a means of reporting or signaling and/or indicating codebook parameters.

In certain embodiments, there may be different NR codebook types. Details about different NR codebook types are provided herein.

In some embodiments, there is an NR Type-II codebook. In such embodiments, assume the gNB is equipped with a 2D antenna array with N₁, N₂ antenna ports per polarization placed horizontally and vertically and communication occurs over N₃ precoder matrix indicator (“PMI”) sub-bands. A PMI subband consists of a set of resource blocks, each resource block consisting of a set of subcarriers. In such case, 2N₁N₂ CSI reference signal (“RS”) (“CSI-RS”) ports are utilized to enable DL channel estimation with high resolution for NR Type-II codebook. In order to reduce the UL feedback overhead, a discrete Fourier transform (“DFT”)-based CSI compression of the spatial domain is applied to L dimensions per polarization, where L<N₁N₂. In the sequel the indices of the 2L dimensions are referred as the SD basis indices. The magnitude and phase values of the linear combination coefficients for each sub-band are fed back to the gNB as part of the CSI report. The 2N₁N₂xN₃ codebook per layer takes on the form: W=W₁W₂, where W₁ is a 2N₁N₂x2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂xL matrix with columns drawn from a 2D oversampled DFT matrix, as follows:

$${u}_{m} = [ \begin{matrix}1 & {e}^{j \frac{2 π m}{{O}_{2} {N}_{2}}} & ⋯ & {e}^{j \frac{2 π m ( {N}_{2} - 1 )}{{O}_{2} {N}_{2}}}\end{matrix} ] ,$$

$${v}_{l , m} = {[ \begin{matrix}{u}_{m} & {e}^{j \frac{2 π l}{{O}_{1} {N}_{1}}} {u}_{m} & ⋯ & {e}^{j \frac{2 π l ( {N}_{1} - 1 )}{{O}_{1} {N}_{1}}}\end{matrix} {u}_{m} ]}^{T} ,$$

$$B = [ \begin{matrix}{v}_{{l}_{0} , {m}_{0}} & {v}_{{l}_{1} , {m}_{1}} & ⋯ & {v}_{{l}_{L - 1} , {m}_{L - 1}} ]\end{matrix} ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} - 1 ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} - 1 ,$$

where the superscript T denotes a matrix transposition operation. Note that O₁, O₂ oversampling factors are assumed for the 2D DFT matrix from which matrix B is drawn. Note that W₁ is common across all layers. W₂ is a 2Lx N₃ matrix, where the i^{th} column corresponds to the linear combination coefficients of the 2L beams in the i^{th} sub-band. Only the indices of the L selected columns of B are reported, along with the oversampling index taking on O₁ and O₂ values. Note that W₂ are independent for different layers.

In certain embodiments Type-II Codebook is as follows:

For 4 antenna ports {3000, 3001, . . . , 3003}, 8 antenna ports {3000, 3001, . . . , 3007}, 12 antenna ports {3000, 3001, . . . , 3011}, 16 antenna ports {3000, 3001, . . . , 3015}, 24 antenna ports {3000, 3001, . . . , 3023}, and 32 antenna ports {3000, 3001, . . . , 3031}, and the UE configured with higher layer parameter codebookType set to ‘typeII’.

The values of N₁ and N₂ are configured with the higher layer parameter n1-n2-codebookSubsetRestriction. The supported configurations of (N₁, N₂) for a given number of CSI-RS ports and the corresponding values of (O₁, O₂) may be given. The number of CSI-RS ports, P_{CSI-RS}, is 2N₁N₂.

The value of L is configured with the higher layer parameter numberOfBeams, where L=2 when P_{CSI-RS}=4 and L∈{2,3,4} when P_{CSI-RS}>4. The value of N_{PSK} is configured with the higher layer parameter phaseAlphabetSize, where N_{PSK}∈{4,8}. The UE is configured with the higher layer parameter subbandAmplitude set to ‘true’ or ‘false’.

The UE shall not report RI>2. When v≤2, where v is the associated RI value, each PMI value corresponds to the codebook indices i₁ and i₂ where:

$${i}_{1} = \{ \begin{matrix}[ \begin{matrix}{i}_{1 , 1} & {i}_{1 , 2} & {i}_{1 , 3 , 1} & {i}_{1 , 4 , 1}\end{matrix} ] & v = 1 \\ [ \begin{matrix}{i}_{1 , 1} & {i}_{1 , 2} & {i}_{1 , 3 , 1} & {i}_{1 , 4 , 1} & {i}_{1 , 3 , 2} & {i}_{1 , 4 , 2}\end{matrix} ] & v = 2\end{matrix}$$

$${i}_{2} = \{ \begin{matrix}[ {i}_{2 , 1 , 1} ] & subbandAmplitude = ‘ false ’ , v = 1 \\ [ \begin{matrix}{i}_{2 , 1 , 1} & {i}_{2 , 1 , 2}\end{matrix} ] & subbandAmplitude = ‘ false ’ , v = 2 \\ [ \begin{matrix}{i}_{2 , 1 , 1} & {i}_{2 , 1 , 2}\end{matrix} ] & subbandAmplitude = ‘ true ’ , v = 1 \\ [ \begin{matrix}{i}_{2 , 1 , 1} & {i}_{2 , 1 , 2} & {i}_{2 , 1 , 2} & {i}_{2 , 2 , 2}\end{matrix} ] & subbandAmplitude = ‘ true ’ , v = 2\end{matrix} ..$$

The L vectors combined by the codebook are identified by the indices i_{1,1} and i_{1,2}, where:

$${i}_{1 , 1} = [ \begin{matrix}{q}_{1} & {q}_{2}\end{matrix} ]$$

$${q}_{1} ∈ \{ 0 , 1 , … {O}_{1} - 1 \}$$

$${q}_{2} ∈ \{ 0 , 1 , … {O}_{2} - 1 \}$$

$${i}_{1 , 2} ∈ \{ 0 , 1 , … , ( \begin{matrix}{N}_{1} {N}_{2} \\ L\end{matrix} ) - 1 \} .$$

Let:

$${n}_{1} = [ {n}_{1}^{( 0 )} , … , {n}_{1}^{( L - 1 )} ]$$

$${n}_{2} = [ {n}_{2}^{( 0 )} , … , {n}_{2}^{( L - 1 )} ]$$

$${n}_{1}^{( i )} ∈ \{ 0 , 1 , … , {N}_{1} - 1 \}$$

$${n}_{2}^{( i )} ∈ \{ 0 , 1 , … , {N}_{2} - 1 \}$$

$$and$$

$$C ( x , y ) = \{ \begin{matrix}( \begin{matrix}x \\ y\end{matrix} ) & x \geq y \\ 0 & x < y\end{matrix} ,$$

where the values of C(x,y) are given in Table 1.

Then the elements of n₁ and n₂ are found from i_{1,2} using the algorithm:

s₋₁=0

for i=0, . . . , L−1

Find the largest x*∈{L−1−i, . . . ,N₁N₂−1−i} in Table 5.2.2.2.3-1 such that i_{1,2-s}_{_{i−1}}≥C(x*,L−i)

$${e}_{i} = C ( x * , L - 1 )$$

$${s}_{i} = {s}_{i - 1} + {e}_{i}$$

$${n}^{( i )} = {N}_{1} {N}_{2} - 1 - x *$$

$${n}_{1}^{( i )} = {n}_{1} mod {N}_{1}$$

$${n}_{2}^{( i )} = \frac{( {n}^{( i )} - {n}_{1}^{( i )} )}{{N}_{1}}$$

When n₁ and n₂ are known, i_{1,2} is found using:

n⁽ⁱ⁾=N₁n₂⁽ⁱ⁾+n₁⁽ⁱ⁾ where the indices i=0,1, . . . , L−1 are assigned such that n⁽ⁱ⁾ increases as i increases
i_{1,2}=Σᵢ₌₀^{L-1}C(N₁N₂−1−n⁽ⁱ⁾, L−i), where C(x,y) is given in Table 1.

If N₂=1, q₂=0 and n₂⁽ⁱ⁾=0 for i=0,1, . . . , L−1, and q₂ is not reported.

When (N₁, N₂)=(2,1), n₁=[0,1] and n₂=[0,0], and i_{1,2} is not reported.

When (N₁, N₂)=(4,1) and L=4, n₁=[0,1,2,3] and n₂=[0,0,0,0], and i_{1,2} is not reported.

When (N₁, N₂)=(2,2) and L=4, n₁=[0,1,0,1] and n₂=[0,0,1,1], and i_{1,2} is not reported.

TABLE 1
Combinatorial coefficients C(x, y)

y

| x | 1 | 2 | 3 | 4 |
|---|---|---|---|---|
| 0 | 0 | 0 | 0 | 0 |
| 1 | 1 | 0 | 0 | 0 |
| 2 | 2 | 1 | 0 | 0 |
| 3 | 3 | 3 | 1 | 0 |
| 4 | 4 | 6 | 4 | 1 |
| 5 | 5 | 10 | 10 | 5 |
| 6 | 6 | 15 | 20 | 15 |
| 7 | 7 | 21 | 35 | 35 |
| 8 | 8 | 28 | 56 | 70 |
| 9 | 9 | 36 | 84 | 126 |
| 10 | 10 | 45 | 120 | 210 |
| 11 | 11 | 55 | 165 | 330 |
| 12 | 12 | 66 | 220 | 495 |
| 13 | 13 | 78 | 286 | 715 |
| 14 | 14 | 91 | 364 | 1001 |
| 15 | 15 | 105 | 455 | 1365 |

The strongest coefficient on layer l=1, . . . , v is identified by i_{1,3,l}∈{0,1, . . . ,2L−1}.

The amplitude coefficient indicators i_{1,4,l} and i_{2,2,l} are:

$${i}_{1 , 4 , l} = [ {k}_{l , 0}^{( 1 )} , {k}_{l , 1}^{( 1 )} , … , {k}_{l , 2 L - 1}^{( 1 )} ]$$

$${i}_{2 , 2 , l} = [ {k}_{l , 0}^{( 2 )} , {k}_{l , 1}^{( 2 )} , … , {k}_{l , 2 L - 1}^{( 2 )} ]$$

$${k}_{l , i}^{( 1 )} ∈ \{ 0 , 1 , … , 7 \}$$

$${k}_{l , i}^{( 2 )} ∈ \{ 0 , 1 \}$$

for l=1, . . . ,v. The mapping from k_{l,i}⁽¹⁾ to the amplitude coefficient p_{l,i}⁽¹⁾ is given in Table 2 and the mapping from k_{l,i}⁽²⁾ to the amplitude coefficient p_{l,i}⁽²⁾ is given in Table 3. The amplitude coefficients are represented by:

$${p}_{l}^{( 1 )} = [ {p}_{l , 0}^{( 1 )} , {p}_{l , 1}^{( 1 )} , … , {p}_{l , 2 L - 1}^{( 1 )} ]$$

$${p}_{l}^{( 2 )} = [ {p}_{l , 0}^{( 2 )} , {p}_{l , 1}^{( 2 )} , … , {p}_{l , 2 L - 1}^{( 2 )} ]$$

for l=1, . . . , v.

TABLE 2
Mapping of elements of i_{1,4,l}: k_{l,i}⁽¹⁾ to p_{l,i}⁽¹⁾

| k_{l,i}⁽¹⁾ | p_{l,i}⁽¹⁾ |
|---|---|
| 0 | 0 |
| 1 | $\sqrt{\frac{1}{64}}$ |
| 2 | $\sqrt{\frac{1}{32}}$ |
| 3 | $\sqrt{\frac{1}{16}}$ |
| 4 | $\sqrt{\frac{1}{8}}$ |
| 5 | $\sqrt{\frac{1}{4}}$ |
| 6 | $\sqrt{\frac{1}{2}}$ |
| 7 | 1 |

TABLE 3
Mapping of elements of i_{2,2,l}: k_{l,i}⁽²⁾ to p_{l,i}⁽²⁾

| k_{l,i}⁽²⁾ | p_{l,i}⁽²⁾ |
|---|---|
| 0 | $\sqrt[]{\frac{1}{2}}$ |
| 1 | 1 |

The phase coefficient indicators are:

$${i}_{2 , 1 , l} = [ {c}_{l , 0} , {c}_{l , 1} , … , {c}_{l , 2 L - 1} ]$$

for l=1, . . . , v.

The amplitude and phase coefficient indicators are reported as follows:

The indicators k_{l,i}_{_{1,3,l}}⁽¹⁾=7, k_{l,i}_{_{1,3,l}}⁽²⁾=1, and c_{l,i}_{_{1,3,l}}=0 (l=1, . . . ,v). k_{l,i}_{_{1,3,l}}⁽¹⁾, k_{l,i}_{_{1,3,l}}⁽²⁾, and c_{l,i}_{_{1,3,l}} are not reported for l=1, . . . , v.

The remaining 2L−1 elements of i_{1,4,l} (l=1, . . . ,v) are reported, where k_{l,i}⁽¹⁾∈{0,1, . . . ,7}. Let Mₗ (l=1, . . . ,v) be the number of elements of i_{1,4,l} that satisfy k_{l,i}⁽¹⁾>0.

The remaining 2L−1 elements of i_{2,1,l} and i_{2,2,l} (l=1, . . . ,v) are reported as follows:

When subbandAmplitude is set to ‘false’,

k_{l,i}⁽²⁾=1 for l=1, . . . , v, and i=0,1, . . . , 2L−1. i_{2,2,l} is not reported for l=1, . . . , v.

For l=1, . . . ,v, the elements of i_{2,1,l} corresponding to the coefficients that satisfy k_{l,i}⁽¹⁾>0, i≠i_{1,3,l}, as determined by the reported elements of i_{1,4,l}, are reported, where C_{l,i}∈{0,1, . . . ,N_{PSK}−1} and the remaining 2L−Mₗ elements of i_{2,1,l} are not reported and are set to c_{l,i}=0.

When subbandAmplitude is set to ‘true’,

For l=1, . . . ,v, the elements of i_{2,2,l} and i_{2,1,l} corresponding to the min(Mₗ, K⁽²⁾)−1 strongest coefficients (excluding the strongest coefficient indicated by i_{1,3,l}), as determined by the corresponding reported elements of i_{1,4,l}, are reported, where k_{l,i}⁽²⁾∈{0,1} and c_{l,i}∈{0,1, . . . ,N_{PSK}−1}. The values of K⁽²⁾ are given in Table 4. The remaining 2L−min(Mₗ, K⁽²⁾) elements of i_{2,2,l} are not reported and are set to k_{l,i}⁽²⁾=1. The elements of i_{2,1,l} corresponding to the Mₗ−min(Mₗ, K⁽²⁾) weakest non-zero coefficients are reported, where c_{l,i}∈{0,1,2,3}. The remaining 2L−Mₗ elements of i_{2,1,l} are not reported and are set to c_{l,}i=0.

When two elements, k_{l,x}⁽¹⁾ and k_{l,y}⁽¹⁾, of the reported elements of i_{1,4,l} are identical (k_{l,x}⁽¹⁾=k_{l,y}⁽¹⁾), then element min(x,y) is prioritized to be included in the set of the min(Mₗ, K⁽²⁾)−1 strongest coefficients for i_{2,1,l} and i_{2,2,l}(l=1, . . . ,v) reporting.

TABLE 4
Full resolution subband coefficients
when subbandAmplitude is set to ‘true’

| L | K⁽²⁾ |
|---|---|
| 2 | 4 |
| 3 | 4 |
| 4 | 6 |

The codebooks for 1-2 layers are given in Table 5, where the indices m₁⁽ⁱ⁾ and m₂⁽ⁱ⁾ are given by:

$${m}_{1}^{( i )} = {O}_{1} {n}_{1}^{( i )} + {q}_{1}$$

$${m}_{2}^{( i )} = {O}_{2} {n}_{2}^{( i )} + {q}_{2} .$$

For i=0,1, . . . ,L−1, and the quantities φ_{l,i}, uₘ, and v_{l,m} are given by

$${φ}_{l , i} = \{ \begin{matrix}{e}^{j 2 π {c}_{l , i} / {N}_{PSK}} & subbandAmplitude = {}^{‵} {false}^{′} \\ {e}^{j 2 π {c}_{l , i} / {N}_{PSK}} & \begin{matrix}subbandAmplitude = {}^{‵} {true}^{′} , min ( {M}_{l} , {K}^{( 2 )} ) strongest \\ coefficients ( including {i}_{1 , 3 , l} ) with {k}_{l , i}^{( i )} > 0\end{matrix} \\ {e}^{j 2 π {c}_{l , i} / 4} & \begin{matrix}subbandAmplitude = {}^{‵} {true}^{′} , {M}_{l} - min ( {M}_{l} , {K}^{( 2 )} ) \\ weakest coefficients with {k}_{l , i}^{( i )} > 0\end{matrix} \\ 1 & subbandAmplitude = {}^{‵} {true}^{′} , 2 L - {M}_{l} coefficients with {k}_{l , i}^{( i )} > 0\end{matrix}$$

$${u}_{m} = \{ \begin{matrix}[ 1 {e}^{j \frac{2 π m}{{O}_{2} {N}_{2}}} … {e}^{j \frac{2 π m ( {N}_{2} - 1 )}{{O}_{2} {N}_{2}}} ] & {N}_{2} > 1 \\ 1 & {N}_{2} = 1\end{matrix}$$

$${v}_{l , m} = {[ {u}_{m} {e}^{j \frac{2 π l}{{O}_{1} {N}_{1}}} … {e}^{j \frac{2 π l ( {N}_{1} - 1 )}{{O}_{1} {N}_{1}}} {u}_{m} ]}^{T} .$$

TABLE 5
Codebook for 1-layer and 2-layer CSI
reporting using antenna ports 3000 to 2999 + PCSI-RS

| Layers | |
|---|---|
| υ = 1 | W_{q}_{₁}_{,q}_{₂}_{,n}_{₁}_{,n}_{₂}_{,p}_{₁}_{⁽¹⁾}_{,p}_{₁}_{⁽²⁾}_{,i}_{_{2,1,1}}⁽¹⁾ = W_{q}_{₁}_{,q}_{₂}_{,n}_{₁}_{,n}_{₂}_{,p}_{₁}_{⁽¹⁾}_{,p}_{₁}_{⁽²⁾}_{,i}_{_{2,1,1}}¹ |
| υ = 2 | $\text{} \begin{matrix}{W}_{{q}_{1} , {q}_{2} , {n}_{1} , {n}_{2} , {p}_{1}^{( 1 )} , {p}_{1}^{( 2 )} , {i}_{2 , 1 , 1} , {p}_{2}^{( 1 )} , {p}_{2}^{( 2 )} , {i}_{2 , 1 , 2}}^{( 2 )} = \\ \frac{1}{\sqrt{2}} [ \begin{matrix}{W}_{{q}_{1} , {q}_{2} , {n}_{1} , {n}_{2} , {p}_{1}^{( 1 )} , {p}_{1}^{( 2 )} , {i}_{2 , 1 , 1}}^{1} & {W}_{{q}_{1} , {q}_{2} , {n}_{1} , {n}_{2} , {p}_{2}^{( 1 )} , {p}_{2}^{( 2 )} , {i}_{2 , 1 , 2}}^{2}\end{matrix} ]\end{matrix}$ |

$\text{} \begin{matrix}where {W}_{{q}_{1} , {q}_{2} , {n}_{1} , {n}_{2} , {p}_{l}^{( 1 )} , {p}_{l}^{( 2 )} , {c}_{l}}^{l} = \\ \frac{1}{\sqrt{{N}_{1} {N}_{2} {\sum }_{i = 0}^{2 L - 1} {( {p}_{l , i}^{( 1 )} {p}_{l , i}^{( 2 )} )}^{2}}} [ \begin{matrix}{\sum }_{i = 0}^{L - 1} {v}_{{m}_{1}^{( i )} , {m}_{2}^{( i )}} {p}_{l , i}^{( 1 )} {p}_{l , i}^{( 2 )} {φ}_{l , i} \\ {\sum }_{i = 0}^{L - 1} {v}_{{m}_{1}^{( i )} , {m}_{2}^{( i )}} {p}_{l , i + L}^{( 1 )} {p}_{l , i + L}^{( 2 )} {φ}_{l , i + L}\end{matrix} ] , l = 1 , 2 , and\end{matrix}$
the mappings from i₁ to q₁, q₂, n₁, n₂, p₁⁽¹⁾, and p₂⁽¹⁾, and from i₂ to
i_{2,1,1}, i_{2,1,2}, p₁⁽²⁾ and p₂⁽²⁾ are as described above, including the ranges
of the constituent indices of i₁ and i₂.

When the UE is configured with higher layer parameter codebookType set to ‘typeII’, the bitmap parameter typeII-RI-Restriction forms the bit sequence r₁, r₀ where r₀ is the least significant bit (“LSB”) and r₁ is the most significant bit (“MSB”). When rᵢ is zero, i∈{0,1}, PMI and RI reporting are not allowed to correspond to any precoder associated with v=i+1 layers. The bitmap parameter n1−n2-codebookSubsetRestriction forms the bit sequence B=B₁B₂ where bit sequences B₁, and B₂ are concatenated to form B. To define B₁ and B₂, first define the O₁O₂ vector groups G(r₁,r₂) as:

$$G ( {r}_{1} , {r}_{2} ) = \{ {v}_{{N}_{1} {r}_{1} + {x}_{1} , {N}_{2} {r}_{2} + {x}_{2}} : {x}_{1} = 0 , 1 , … , {N}_{1} - 1 ; {x}_{2} = 0 , 1 , … , {N}_{2} - 1 \}$$

for

$${r}_{1} ∈ \{ 0 , 1 , … , {0}_{1} - 1 \}$$

$${r}_{2} ∈ \{ 0 , 1 , … , {0}_{2} - 1 \} .$$

The UE shall be configured with restrictions for 4 vector groups indicated by (r₁^{(k)},r₂^{(k)}) for k=0,1,2,3 and identified by the group indices:

$${g}^{( k )} = {O}_{1} {r}_{2}^{( k )} + {r}_{1}^{( k )} .$$

For k=0,1, . . . ,3, where the indices are assigned such that g^{(k)} increases as k increases. The remaining vector groups are not restricted.

If N₂=1, g^{(k)}=k for k=0,1, . . . ,3, and B₁ is empty.

If N₂>1, B₁=b₁⁽¹⁰⁾ . . . b₁⁽⁰⁾ is the binary representation of the integer β₁ where b₁⁽¹⁰⁾ is the MSB and b₁⁽⁰⁾ is the LSB. β₁ is found using:

$${β}_{1} = {\sum }_{k = 0}^{3} C ( {O}_{1} {O}_{2} - 1 - {g}^{( k )} , 4 - k ) ,$$

where C(x,y) is defined in Table 1. The group indices g(k) and indicators (r₁^{(k)}, r₂^{(k)}) for k=0,1,2,3 may be found from β₁ using the algorithm:

$${s}_{- 1} = 0$$

for k=0, . . . ,3:

Find the largest x*∈{3−k, . . . , O₁O₂−1−k} such that β₁−sₖ₋₁≥C(x*, 4−k)

$${e}_{k} = C ( {x}^{*} , 4 - k )$$

$${s}_{k} = {s}_{k - 1} + {e}_{k}$$

$${g}^{( k )} = {O}_{1} {O}_{2} - 1 - {x}^{*}$$

$${r}_{1}^{( k )} = {g}^{( k )} mod {O}_{1}$$

$${r}_{2}^{( k )} = \frac{( {g}^{( k )} - {r}_{1}^{( k )} )}{{o}_{1}} .$$

The bit sequence B₂=B₂⁽⁰⁾B₂⁽¹⁾B₂⁽²⁾ B₂⁽³⁾ is the concatenation of the bit sequences B₂^{(k)} for k=0,1, . . . ,3, corresponding to the group indices g^{(k)}. The bit sequence B₂^{(k)} is defined as

$${B}_{2}^{( k )} = {b}_{2}^{( k , 2 {N}_{1} {N}_{2} - 1 )} … {b}_{2}^{( k , 0 )} .$$

Bits b₂^{k,2(N}^{₁}^{x}^{₂}^{+x}^{₁}⁾⁺¹⁾b₂^{(k,2(N}^{₁}^{x}^{₂}^{+x}^{₁}⁾⁾ indicate the maximum allowed amplitude coefficient p_{l,i}⁽¹⁾ for the vector in group g^{(k)} indexed by x₁,x₂, where the maximum amplitude coefficients are given in Table 6. A UE that does not report parameter amplitude SubsetRestriction=‘supported’ in its capability signaling is not expected to be configured with b₂^{(k,2(N}^{₁}^{x}^{₂}^{+x}^{₁}⁾⁺¹⁾b₂^{(k,2(N}^{₁}^{x}^{₂}^{+x}^{₁}⁾⁾=01 or 10.

TABLE 6
Maximum allowed amplitude coefficients for restricted vectors

| Bits | Maximum Amplitude |
|---|---|
| b₂^{(k,2(N}^{₁}^{x}^{₂}^{+x}^{₁}⁾⁺¹⁾b₂^{(k,2(N}^{₁}^{x}^{₂}^{+x}^{₁}⁾⁾ | Coefficient p_{l,i}⁽¹⁾ |
| 00 | 0 |
| 01 | $\sqrt{\frac{1}{4}}$ |
| 10 | $\sqrt{\frac{1}{2}}$ |
| 11 | 1 |

In various embodiments, there may be an NR Type-II port selection codebook. In such embodiments, for Type-II port selection codebook, only K (where K≤2N₁N₂) beamformed CSI-RS ports are utilized in DL transmission, in order to reduce complexity. The KxN3 codebook matrix per layer takes on the form: W=W₁^{PS}W₂.

Here, W₂ follow the same structure as the conventional NR Rel. 15 Type-II Codebook and are layer specific. W₁^{PS} is a Kx2L block-diagonal matrix with two identical diagonal blocks, i.e.,

$${W}_{1}^{P S} = [ \begin{matrix}E & 0 \\ 0 & E\end{matrix} ] ,$$

### and E is an

$$\frac{K}{2} \times L$$

matrix whose columns are standard unit vectors, as follows:

$$E = [ \begin{matrix}{e}_{mod ( {m}_{PS} {d}_{P S} , K / 2 )}^{( K / 2 )} & \begin{matrix}\begin{matrix}{e}_{mod ( {m}_{PS} {d}_{P S} + 1 , K / 2 )}^{( K / 2 )} & …\end{matrix} & {e}_{mod ( {m}_{PS} {d}_{P S} + L - 1 , K / 2 )}^{( K / 2 )}\end{matrix}\end{matrix} ] ,$$

where eᵢ^{(k)} is a standard unit vector with a 1 at the ith location. Here d_{PS} is a radio resource control (“RRC”) parameter which takes on the values {1,2,3,4} under the condition d_{PS}≤min(K/2, L), whereas m_{PS} takes on the values

$$\{ 0 , … , ⌈ \frac{K}{2 {d}_{P S}} ⌉ - 1 \}$$

and is reported as part of the UL CSI feedback overhead. W₁ is common across all layers. For K=16, L=4 and d_{PS}=1, the 8 possible realizations of E corresponding to m_{PS}={0,1, . . . ,7} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ] .$$

When d_{PS}=2, the 4 possible realizations of E corresponding to m_{PS}={0,1,2,3} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0,1,2} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=4, the 2 possible realizations of E corresponding of m_{PS}={0,1} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first 1 in the first column of E, whereas d_{PS} represents the row shift corresponding to different values of m_{PS}.

In more detail, Type-II Port Selection Codebook may be as follows:

For 4 antenna ports {3000, 3001, . . . , 3003}, 8 antenna ports {3000, 3001, . . . , 3007}, 12 antenna ports {3000, 3001, . . . , 3011}, 16 antenna ports {3000, 3001, . . . , 3015}, 24 antenna ports {3000, 3001, . . . , 3023}, and 32 antenna ports {3000, 3001, . . . , 3031}, and the UE configured with higher layer parameter codebookType set to ‘typeII-PortSelection’.

The number of CSI-RS ports is given by P_{CSI-RS}∈{4,8,12,16,24,32} as configured by higher layer parameter nrofPorts.

The value of L is configured with the higher layer parameter numberOfBeams, where L=2 when P_{CSI-RS}=4 and L∈{2,3,4} when P_{CSI-RS}>4.

The value of d is configured with the higher layer parameter portSelectionSamplingSize, where d∈{1,2,3,4} and

$$d \leq min ( \frac{{P}_{CSI - RS}}{2} , L ) .$$

The value of N_{PSK} is configured with the higher layer parameter phaseAlphabetSize, where N_{PSK}∈{4,8}.

The UE is configured with the higher layer parameter subbandAmplitude set to ‘true’ or ‘false’.

The UE shall not report RI>2.

The UE is also configured with the higher layer parameter typeII-PortSelectionRI-Restriction. The bitmap parameter typeII-PortSelectionRI-Restriction forms the bit sequence r₁,r₀ where r₀ is the LSB and r₁ is the MSB. When rᵢ is zero, i∈{0,1}, PMI and RI reporting are not allowed to correspond to any precoder associated with v=i+1 layers.

When v≤2, where v is the associated RI value, each PMI value corresponds to the codebook indices i₁ and i₂ where:

$${i}_{1} = \{ \begin{matrix}[ \begin{matrix}{i}_{1 , 1} & {i}_{1 , 3 , 1} & {i}_{1 , 4 , 1}\end{matrix} ] & v = 1 \\ [ \begin{matrix}{i}_{1 , 1} & {i}_{1 , 3 , 1} & {i}_{1 , 4 , 1} & {i}_{1 , 3 , 2} & {i}_{1 , 4 , 2}\end{matrix} ] & v = 2\end{matrix}$$

$${i}_{2} = \{ \begin{matrix}[ {i}_{2 , 1 , 1} ] & subbandAmplitude = ‘ false ’ , v = 1 \\ [ \begin{matrix}{i}_{2 , 1 , 1} & {i}_{2 , 1 , 2}\end{matrix} ] & subbandAmplitude = ‘ false ’ , v = 2 \\ [ \begin{matrix}{i}_{2 , 1 , 1} & {i}_{2 , 2 , 1}\end{matrix} ] & subbandAmplitude = ‘ true ’ , v = 1 \\ [ \begin{matrix}{i}_{2 , 1 , 1} & {i}_{2 , 2 , 1} & {i}_{2 , 1 , 2} & {i}_{2 , 2 , 2}\end{matrix} ] & subbandAmplitude = ‘ true ’ , v = 2\end{matrix} .$$

The L antenna ports per polarization are selected by the index i_{1,1}, where:

$${i}_{1 , 1} ∈ \{ 0 , 1 , … , ⌈ \frac{{P}_{CSI - RS}}{2 d} ⌉ - 1 \} .$$

The strongest coefficient on layer l, l=1, . . . ,v is identified by i_{1,3,l}∈{0,1, . . . ,2L−1}.

The amplitude coefficient indicators i_{1,4,l} and i_{2,2,l} are:

$${i}_{1 , 4 , l} = [ {k}_{l , 0}^{( 1 )} , {k}_{l , 1}^{( 1 )} , … , {k}_{l , 2 L - 1}^{( 1 )} ]$$

$${i}_{2 , 2 , l} = [ {k}_{l , 0}^{( 2 )} , {k}_{l , 1}^{( 2 )} , … , {k}_{l , 2 L - 1}^{( 2 )} ]$$

$${k}_{l , i}^{( 1 )} ∈ \{ 0 , 1 , … , 7 \}$$

$${k}_{l , i}^{( 2 )} ∈ \{ 0 , 1 \}$$

for l=1, . . . ,v. The mapping from k_{l,i}⁽¹⁾ to the amplitude coefficient p_{l,i}⁽¹⁾ is given in Table 2 and the mapping from k_{l,i}⁽²⁾ to the amplitude coefficient p_{l,i}⁽²⁾ is given in Table 3. The amplitude coefficients are represented by:

$${p}_{l}^{( 1 )} = [ {p}_{l , 0}^{( 1 )} , {p}_{l , 1}^{( 1 )} , … , {p}_{l , 2 L - 1}^{( 1 )} ]$$

$${p}_{l}^{( 2 )} = [ {p}_{l , 0}^{( 2 )} , {p}_{l , 1}^{( 2 )} , … , {p}_{l , 2 L - 1}^{( 2 )} ]$$

for l=1, . . . ,v.

The phase coefficient indicators are

$${i}_{2 , 1 , l} = [ {c}_{l , 0} , {c}_{l , 1} , … , {c}_{l , 2 L - 1} ]$$

for l=1, . . . , v.

The amplitude and phase coefficient indicators are reported as follows:

The indicators k_{l,i}_{_{1,3,l}}⁽¹⁾=7, k_{l,i}_{_{1,3,l}}⁽²⁾=1, and c_{l,i}_{_{1,3,l}}=0 (l=1, . . . , u). k_{l,i}_{_{1,3,l}}⁽¹⁾, k_{l,i}_{_{1,3,l}}⁽²⁾, and c_{l,i}_{_{1,3,l}} are not reported for l=1, . . . , v.

The remaining 2L−1 elements of i_{1,4,l} (l=1, . . . ,v) are reported, where k_{l,i}⁽¹⁾∈{0,1, . . . ,7}. Let Mₗ(l=1, . . . ,v) be the number of elements of i_{1,4,l} that satisfy k_{l,i}⁽¹⁾>0.

The remaining 2L−1 elements of i_{2,1,l} and i_{2,2,l} (l=1, . . . ,v) are reported as follows:

When subbandAmplitude is set to ‘false’,

k_{l,i}⁽²⁾=1 for l=1, . . . , v, and i=0,1, . . . ,2L−1. i_{2,2,l} is not reported for l=1, . . . , v.

For l=1, . . . ,v, the Mₗ−1 elements of i_{2,1,l} corresponding to the coefficients that satisfy k_{l,i}⁽¹⁾>0, i≠i_{1,3,l}, as determined by the reported elements of i_{1,4,l}, are reported, where c_{l,i}∈{0,1, . . . ,N_{PSK}−1} and the remaining 2L−Mₗ elements of i_{2,1,l} are not reported and are set to c_{l,i}=0.

When subbandAmplitude is set to ‘true’,

For l=1, . . . ,v, the elements of i_{2,2,l} and i_{2,1,l} corresponding to the min(Mₗ,K⁽²⁾)−1 strongest coefficients (excluding the strongest coefficient indicated by i_{1,3,l}), as determined by the corresponding reported elements of i_{1,4,l}, are reported, where k_{l,i}⁽²⁾∈{0,1} and c_{l,i}∈{0,1, . . . ,N_{PSK}-1}. The values of K⁽²⁾ are given in Table 4. The remaining 2L−min(Mₗ,K⁽²⁾) elements of i_{2,2,l} are not reported and are set to k_{l,i}⁽²⁾=1. The elements of i_{2,1,l} corresponding to the Mₗ−min(Mₗ,K⁽²⁾) weakest non-zero coefficients are reported, where c_{l,i}∈{0,1,2,3}. The remaining 2L−Mₗ elements of i_{2,1,l} are not reported and are set to c_{l,i}=0.

When two elements, k_{l,x}⁽¹⁾ and k_{l,y}⁽¹⁾ of the reported elements of i_{1,4,l} are identical (k_{l,x}⁽¹⁾=k_{l,y}⁽¹⁾), then element min(x,y) is prioritized to be included in the set of the min(Mₗ,K⁽²⁾)−1 strongest coefficients for i_{2,1,l} and i_{2,2,l}(l=1, . . . ,v) reporting.

The codebooks for 1-2 layers are given in Table 7, where the quantity φ_{l,i} is given by:

$${φ}_{l , i} = \{ \begin{matrix}{e}^{j \frac{2 π {c}_{l , i}}{{N}_{PSK}}} & subbandAmplitude = ‘ false ’ \\ {e}^{j \frac{2 π {c}_{l , i}}{{N}_{PSK}}} & subbandAmplitude = ‘ true ’ , min ( {M}_{l} , {K}^{( 2 )} ) strongest coefficients ( including {i}_{1 , 3 , l} ) with {k}_{l , i}^{( 1 )} > \\ {e}^{j \frac{2 π {c}_{l , i}}{4}} & subbandAmplitude = ‘ true ’ , {M}_{l} - min ( {M}_{l} , {K}^{( 2 )} ) weakest coefficients with {k}_{l , i}^{( 1 )} > 0 \\ 1 & subbandAmplitude = ‘ true ’ , 2 L - {M}_{l} coefficients with {k}_{l , i}^{( 1 )} = 0\end{matrix}$$

And vₘ is a P_{CSI-RS}/2-element column vector containing a value of 1 in element (m mod P_{CSI-RS}/2) and zeros elsewhere (where the first element is element 0).

TABLE 7
Codebook for 1-layer and 2-layer CSI
reporting using antenna ports 3000 to 2999 + P_{CSI-RS}

| Layers | |
|---|---|
| υ = 1 | Wᵢ_{_{1,1}}_{,p}_{₁}_{⁽¹⁾}_{,p}_{₁}_{⁽²⁾}_{,i}_{_{2,1,1}}⁽¹⁾ = Wᵢ_{_{1,1}}_{,p}_{₁}_{⁽¹⁾}_{,p}_{₁}_{⁽²⁾}_{,i}_{_{2,1,1}}¹ |
| υ = 2 | $\text{} \begin{matrix}{W}_{{i}_{1 , 1} , {p}_{1}^{( 1 )} , {p}_{1}^{( 2 )} , {i}_{2 , 1 , 1} , {p}_{2}^{( 1 )} , {p}_{2}^{( 2 )} , {i}_{2 , 1 , 2}}^{( 2 )} = \\ \frac{1}{\sqrt{2}} [ \begin{matrix}{W}_{{i}_{1 , 1} , {p}_{1}^{( 1 )} , {p}_{1}^{( 2 )} , {i}_{2 , 1 , 1}}^{1} & {W}_{{i}_{1 , 1} , {p}_{2}^{( 1 )} , {p}_{2}^{( 2 )} , {i}_{2 , 1 , 2}}^{2}\end{matrix} ]\end{matrix}$ |

$\text{} \begin{matrix}where {W}_{{i}_{1 , 1} , {p}_{l}^{( 1 )} , {p}_{l}^{( 2 )} , {i}_{2 , 1 , l}}^{l} = \\ \frac{1}{\sqrt{{\sum }_{i = 0}^{2 L - 1} {( {p}_{l , i}^{( 1 )} {p}_{l , i}^{( 2 )} )}^{2}}} [ \begin{matrix}{\sum }_{i = 0}^{L - 1} {v}_{{i}_{1 , 1} d + i} {p}_{l , i}^{( 1 )} {p}_{l , i}^{( 2 )} {φ}_{l , i} \\ {\sum }_{i = 0}^{L - 1} {v}_{{i}_{1 , 1} d + i} {p}_{l , i + L}^{( 1 )} {p}_{l , i + L}^{( 2 )} {φ}_{l , i + L}\end{matrix} ] , l = 1 , 2 , and the\end{matrix}$
mappings from i₁ to i_{1,1}, p₁⁽¹⁾, and p₂⁽¹⁾ and from i₂ to i_{2,1,1}, i_{2,1,2}, p₁⁽²⁾,
and p₂⁽²⁾ are as described above, including the ranges of the constituent
indices of i₁ and i₂.

In various embodiments, there may be an NR Type-I codebook. In such embodiments, NR Type-I codebook is the baseline codebook for NR, with a variety of configurations. The most common utility of Type-I codebook is a special case of NR Type-II codebook with L=1 for RI=1,2, wherein a phase coupling value is reported for each sub-band, i.e., W₂ is 2xN₃, with the first row equal to [1, 1, . . . , 1] and the second row equal to [e^{j2πØ}^{₀}, . . . , e^{j2πØ}^{_{N3−1}}]. Under specific configurations, ϕ₀=ϕ₁ . . . =ϕ, i.e., wideband reporting. For RI>2 different beams are used for each pair of layers. Obviously, NR Rel. 15 Type-I codebook can be depicted as a low-resolution version of NR Rel. 15 Type-II codebook with spatial beam selection per layer-pair and phase combining only.

In certain embodiments, there may be an NR Type-II codebook. In such embodiments, assume the gNB is equipped with a two-dimensional (2D) antenna array with N₁, N₂ antenna ports per polarization placed horizontally and vertically and communication occurs over N₃ PMI sub-bands. A PMI sub-band consists of a set of resource blocks, each resource block consisting of a set of subcarriers. In such case, 2N₁N₂N₃ CSI-RS ports are utilized to enable DL channel estimation with high resolution for NR Type-II codebook. In order to reduce the UL feedback overhead, a Discrete Fourier transform (DFT)-based CSI compression of the spatial domain is applied to L dimensions per polarization, where L<N₁N₂. Similarly, additional compression in the frequency domain is applied, where each beam of the frequency-domain precoding vectors is transformed using an inverse DFT matrix to the delay domain, and the magnitude and phase values of a subset of the delay-domain coefficients are selected and fed back to the gNB as part of the CSI report. The 2N₁N₂xN₃ codebook per layer takes on the form:

W=W₁\tilde{W}₂W_{f}^{H},

where W₁ is a 2N₁N₂x2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂xL matrix with columns drawn from a 2D oversampled DFT matrix, as follows:

$${u}_{m} = [ \begin{matrix}1 & {e}^{j \frac{2 π m}{{O}_{2} {N}_{2}}} & ⋯ & {e}^{j \frac{2 π m ( {N}_{2} - 1 )}{{O}_{2} {N}_{2}}}\end{matrix} ] ,$$

$${v}_{l , m} = {[ \begin{matrix}{u}_{m} & {e}^{j \frac{2 π l}{{O}_{1} {N}_{1}}} {u}_{m} & ⋯ & {e}^{j \frac{2 π l ( {N}_{1} - 1 )}{{O}_{1} {N}_{1}}} {u}_{m}\end{matrix} ]}^{T} ,$$

$$B = [ \begin{matrix}{v}_{{l}_{0} , {m}_{0}} & {v}_{{l}_{1} , {m}_{1}} & ⋯ & {v}_{{l}_{L - 1} , {m}_{L - 1}} ]\end{matrix} ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} - 1 ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} - 1.$$

Note that O₁, O₂ oversampling factors are assumed for the 2D DFT matrix from which matrix B is drawn. Note that W₁ is common across all layers. W_{f} is an N₃xM matrix (M<N₃) with columns selected from a critically sampled size-N₃ DFT matrix, as follows:

$${W}_{f} = [ \begin{matrix}{f}_{{k}_{0}} & {f}_{{k}_{1}} & ⋯ & {f}_{{k}_{{M}^{′} - 1}} ]\end{matrix} , 0 \leq {k}_{i} < {N}_{3} - 1 ,$$

$${f}_{k} = [ {\begin{matrix}1 & {e}^{- j \frac{2 π k}{{N}_{3}}} & ⋯ & {e}^{- j \frac{2 π k ( {N}_{3} - 1 )}{{N}_{3}}} ]\end{matrix}}^{T} .$$

Only the indices of the L selected columns of B are reported, along with the oversampling index taking on O₁ and O₂ values. Similarly, for W_{f}, only the indices of the M selected columns out of the predefined size-N₃ DFT matrix are reported. In the sequel the indices of the M dimensions are referred as the selected frequency domain (“FD”) basis indices. Hence, L, M represent the equivalent spatial and frequency dimensions after compression, respectively. Finally, the 2LxM matrix \tilde{W}₂ represents the linear combination coefficients (“LCCs”) of the spatial and frequency DFT-basis vectors. Both \tilde{W}₂, W_{f} are selected independent for different layers. Magnitude and phase values of an approximately β fraction of the 2LM available coefficients are reported to the gNB (β<1) as part of the CSI report. Coefficients with zero magnitude are indicated via a per-layer bitmap. Since all coefficients reported within a layer are normalized with respect to the coefficient with the largest magnitude (strongest coefficient), the relative value of that coefficient is set to unity, and no magnitude or phase information is explicitly reported for this coefficient. Only an indication of the index of the strongest coefficient per layer is reported. Hence, for a single-layer transmission, magnitude and phase values of a maximum of [2βLM]−1 coefficients (along with the indices of selected L, M DFT vectors) are reported per layer, leading to significant reduction in CSI report size, compared with reporting 2N₁N₂xN₃−1 coefficients' information.

In more detail, the specification for the Type-II Codebook is as follows:

For 4 antenna ports {3000, 3001, . . . , 3003}, 8 antenna ports {3000, 3001, 3007}, 12 antenna ports {3000, 3001, . . . , 3011}, 16 antenna ports {3000, 3001, . . . , 3015}, 24 antenna ports {3000, 3001, . . . , 3023}, and 32 antenna ports {3000, 3001, . . . , 3031}, and UE configured with higher layer parameter codebookType set to ‘typeII-r16’.

The values of N₁ and N₂ are configured with the higher layer parameter n1−n2-codebookSubsetRestriction-r16. The supported configurations of (N₁, N₂) for a given number of CSI-RS ports and the corresponding values of (O₁, O₂) are given. The number of CSI-RS ports, P_{CSI-RS}, is 2N₁N₂.

The values of L, β and pᵤ are determined by the higher layer parameter paramCombination-r16, where the mapping is given in Table 1.

The UE is not expected to be configured with paramCombination-r16 equal to:
3, 4, 5, 6, 7, or 8 when P_{CSI-RS}=4,
7 or 8 when P_{CSI-RS}<32,
7 or 8 when higher layer parameter typeII-RI-Restriction-r16 is configured with rᵢ=1 for any i>1,
7 or 8 when R=2.

The parameter R is configured with the higher-layer parameter numberOfPMISubbandsPerCQISubband-r16. This parameter controls the total number of precoding matrices N₃ indicated by the PMI as a function of the number of configured subbands in csi-ReportingBand, the subband size configured by the higher-level parameter subbandSize and of the total number of physical resource blocks (“PRBs”) in the bandwidth part, as follows:

When R=1:

One precoding matrix is indicated by the PMI for each subband in csi-ReportingBand.

When R=2:

For each subband in csi-ReportingBand that is not the first or last subband of a bandwidth part (“BWP”), two precoding matrices are indicated by the PMI: the first precoding matrix corresponds to the first N_{PRB}^{SB}/2 PRBs of the subband and the second precoding matrix corresponds to the last N_{PRB}^{SB}/2 PRBs of the subband.

For each subband in csi-ReportingBand that is the first or last subband of a BWP:

If

$$( {N}_{BWP , i}^{start} mod {N}_{PRB}^{SB} ) \geq \frac{{N}_{PRB}^{SB}}{2} ,$$

one precoding matrix is indicated by the PMI corresponding to the first subband. If

$$( {N}_{BWP , i}^{start} mod {N}_{PRB}^{SB} ) < \frac{{N}_{PRB}^{SB}}{2} ,$$

two precoding matrices are indicated by the PMI corresponding to the first subband: the first precoding matrix corresponds to the first

$$\frac{{N}_{PRB}^{SB}}{2} - ( {N}_{BWP , i}^{start} mod {N}_{PRB}^{SB} )$$

PRBs of the first subband and the second precoding matrix corresponds to the last N_{PRB}^{SB}/2 PRBs of the first subband.

If

$$1 + ( {N}_{BWP , i}^{start} + {N}_{BWP , i}^{size} - 1 ) mod {N}_{PRB}^{SB} \leq \frac{{N}_{PRB}^{SB}}{2} ,$$

one precoding matrix is indicated by the PMI corresponding to the last subband. If

$$1 + ( {N}_{BWP , i}^{start} + {N}_{BWP , i}^{size} - 1 ) mod {N}_{PRB}^{SB} > \frac{{N}_{PRB}^{SB}}{2} ,$$

two precoding matrices are indicated by the PMI corresponding to the last subband: the first precoding matrix corresponds to the first

$$\frac{{N}_{P R B}^{S B}}{2}$$

PRBs of the last subband and the second precoding matrix corresponds to the last

$$1 + ( {N}_{BWP , i}^{start} + {N}_{BWP , i}^{size} - 1 ) mod {N}_{PRB}^{SB} - \frac{{N}_{PRB}^{SB}}{2}$$

PRBs of the last subband.

TABLE 8
Codebook parameter configurations for L, β and pᵥ

| | |
|---|---|
| paramCombination- | pᵥ |

| r16 | L | v ∈ {1, 2} | v ∈ {3, 4} | β |
|---|---|---|---|---|
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |
| 7 | 6 | ¼ | — | ½ |
| 8 | 6 | ¼ | — | ¾ |

The UE shall report the RI value u according to the configured higher layer parameter typeII-RI-Restriction-r16. The UE shall not report u>4.

The PMI value corresponds to the codebook indices of i₁ and i₂ where:

$${i}_{1} = \{ \begin{matrix}[ {i}_{1 , 1} {i}_{1 , 2} {i}_{1 , 5} {i}_{1 , 6 , 1} {i}_{1 , 7 , 1} {i}_{1 , 8 , 1} ] & v = 1 \\ [ {i}_{1 , 1} {i}_{1 , 2} {i}_{1 , 5} {i}_{1 , 6 , 1} {i}_{1 , 7 , 1} {i}_{1 , 8 , 1} {i}_{1 , 6 , 2} {i}_{1 , 7 , 2} {i}_{1 , 8 , 2} ] & v = 2 \\ [ {i}_{1 , 1} {i}_{1 , 2} {i}_{1 , 5} {i}_{1 , 6 , 1} {i}_{1 , 7 , 1} {i}_{1 , 8 , 1} {i}_{1 , 6 , 2} {i}_{1 , 7 , 2} {i}_{1 , 8 , 2} {i}_{1 , 6 , 3} {i}_{1 , 7 , 3} {i}_{1 , 8 , 3} ] & v = 3 \\ [ {i}_{1 , 1} {i}_{1 , 2} {i}_{1 , 5} {i}_{1 , 6 , 1} {i}_{1 , 7 , 1} {i}_{1 , 8 , 1} {i}_{1 , 6 , 2} {i}_{1 , 7 , 2} {i}_{1 , 8 , 2} {i}_{1 , 6 , 3} {i}_{1 , 7 , 3} {i}_{1 , 8 , 3} {i}_{1 , 6 , 4} {i}_{1 , 7 , 4} {i}_{1 , 8 , 4} ] & v = 4\end{matrix}$$

$${i}_{2} = \{ \begin{matrix}[ {i}_{2 , 3 , 1} {i}_{2 , 4 , 1} {i}_{2 , 5 , 1} ] & v = 1 \\ [ {i}_{2 , 3 , 1} {i}_{2 , 4 , 1} {i}_{2 , 5 , 1} {i}_{2 , 3 , 2} {i}_{2 , 4 , 2} {i}_{2 , 5 , 2} ] & v = 2 \\ [ {i}_{2 , 3 , 1} {i}_{2 , 4 , 1} {i}_{2 , 5 , 1} {i}_{2 , 3 , 2} {i}_{2 , 4 , 2} {i}_{2 , 5 , 2} {i}_{2 , 3 , 3} {i}_{2 , 4 , 3} {i}_{2 , 5 , 3} ] & v = 3 \\ [ {i}_{2 , 3 , 1} {i}_{2 , 4 , 1} {i}_{2 , 5 , 1} {i}_{2 , 3 , 2} {i}_{2 , 4 , 2} {i}_{2 , 5 , 2} {i}_{2 , 3 , 3} {i}_{2 , 4 , 3} {i}_{2 , 5 , 3} {i}_{2 , 3 , 4} {i}_{2 , 4 , 4} {i}_{2 , 5 , 4} ] & v = 4\end{matrix}$$

The precoding matrices indicated by the PMI are determined from L+Mᵤ vectors.

L vectors, vₘ_{₁}_{⁽ⁱ⁾}_{,m}_{₂}_{⁽ⁱ⁾}, i=0,1, . . . , L−1, are identified by the indices q₁, q₂, n₁, n₂, indicated by i_{1,1}, i_{1,2}, where the values of C(x,y) are given.

$${M}_{υ} = ⌈ {p}_{υ} \frac{{N}_{3}}{R} ⌉ vectors , {[ {y}_{0 , l}^{( f )} , {y}_{1 , l}^{( f )} , … , {y}_{{N}_{3} - 1 , l}^{( f )} ]}^{T} , f = 0 , 1 , … , {M}_{υ} - 1 ,$$

are identified by Mᵢₙᵢₜᵢₐₗ (for N₃>19) and n_{3,l} (l=1, . . . , u) where:

$${M}_{initiαl} ∈ \{ - 2 {M}_{v} + 1 , - 2 {M}_{v} + 2 , … , 0 \} ,$$

$${n}_{3 , l} = [ {n}_{3 , l}^{( 0 )} , … , {n}_{3 , l}^{( {M}_{v} - 1 )} ] ,$$

$${n}_{3 , l}^{( f )} ∈ \{ 0 , 1 , … , {N}_{3} - 1 \} ,$$

which are indicated by means of the indices i_{1,5} (for N₃>19) and i_{1,6,l} (for Mᵤ>1 and l=1, . . . , u), where:

$${i}_{1 , 5} ∈ \{ 0 , 1 , … , 2 {M}_{v} - 1 \} ,$$

$${i}_{1 , 6 , l} ∈ \{ \begin{matrix}\{ 0 , 1 , … , ( \begin{matrix}{N}_{3} - 1 \\ {M}_{v} - 1\end{matrix} ) - 1 \} & {N}_{3} \leq 19 \\ \{ 0 , 1 , … , ( \begin{matrix}2 {M}_{v} - 1 \\ {M}_{v} - 1\end{matrix} ) - 1 \} & {N}_{3} > 19\end{matrix} .$$

The amplitude coefficient indicators i_{2,3,l} and i_{2,4,l} are:

$${i}_{2 , 3 , l} = [ {k}_{l , 0}^{( 1 )} {k}_{l , 1}^{( 1 )} ] ,$$

$${i}_{2 , 4 , l} = [ {k}_{l , 0}^{( 2 )} … {k}_{l , {M}_{v} - 1}^{( 2 )} ] ,$$

$${k}_{l , f}^{( 2 )} = [ {k}_{l , 0 , f}^{( 2 )} … {k}_{l , 2 L - 1 , f}^{( 2 )} ] ,$$

$${k}_{l , p}^{( 1 )} ∈ \{ 1 , … , 15 \} ,$$

$${k}_{l , i , f}^{( 2 )} ∈ \{ 0 , … , 7 \} ,$$

and
for l=1, . . . , v.

The phase coefficient indicator i_{2,5,l} is:

$${i}_{2 , 5 , l} = [ {c}_{l , 0} … {c}_{l , {M}_{v} - 1} ] ,$$

$${c}_{l , f} = [ {c}_{l , 0 , f} … {c}_{l , 2 L - 1 , f} ] ,$$

$${c}_{l , i , f} ∈ \{ 0 , … , 15 \} ,$$

for l=1, . . . , v.

Let K₀=┌β2LM₁┐. The bitmap whose nonzero bits identify which coefficients in i_{2,4,l} and i_{2,5,l} are reported, is indicated by i_{1,7,l}:

$${i}_{1 , 7 , l} = [ {k}_{l , 0}^{( 3 )} … {k}_{l , {M}_{v} - 1}^{( 3 )} ] ,$$

$${k}_{l , f}^{( 3 )} = [ {k}_{l , 0 , f}^{( 3 )} … {k}_{l , 2 L - 1 , f}^{( 3 )} ] ,$$

$${k}_{l , i , f}^{( 3 )} ∈ \{ 0 , 1 \} ,$$

for l=1, . . . , u, such that Kₗ^{NZ}=Σᵢ₌₀^{2L-l}Σ_{f=0}^{M}^{ᵤ}⁻¹k_{l,i,f}⁽³⁾≤K₀ is the number of nonzero coefficients for layer l=1, . . . , u and K^{NZ}=Σₗ₌₁^{u}Kₗ^{NZ}≤2K₀ is the total number of nonzero coefficients.

The indices of i_{2,4,l}, i_{2,5,l} and i_{1,7,l} are associated to the Mᵤ codebook indices in n_{3,l}.

The mapping from k_{l,p}⁽¹⁾ to the amplitude coefficient p_{l,p}⁽¹⁾ is given in Table 2 and the mapping from k_{l,i,f}⁽²⁾ to the amplitude coefficient P_{l,i,f}⁽²⁾ is given in Table 3. The amplitude coefficients are represented by:

$${p}_{l}^{( 1 )} = [ {p}_{l , 0}^{( 2 )} {p}_{l , {M}_{v} - 1}^{( 2 )} ] ,$$

$${p}_{l}^{( 2 )} = [ {p}_{l , 0}^{( 2 )} … {p}_{l , {M}_{v} - 1}^{( 2 )} ] ,$$

$${p}_{l , f}^{( 2 )} = [ {p}_{l , 0 , f}^{( 2 )} … {p}_{l , 2 L - 1 , f}^{( 2 )} ] ,$$

for l=1, . . . , u.

Let fₗ*∈{0,1, . . . , Mᵤ−1} be the index of i_{2,4,l} and iₗ*∈{0,1, . . . ,2L−1} be the index of k_{l,f}_{ₗ}_{*}⁽²⁾ which identify the strongest coefficient of layer l, i.e., the element k_{l,i}_{ₗ}_{*,f}_{ₗ}_{*}⁽²⁾ of i_{2,4,l}, for l=1, . . . , u. The codebook indices of n_{3,l} are remapped with respect to no (i) as n_{3,l}^{(f}^{ₗ}^{*)} as n_{3,l}^{(f)}=(n_{3,l}^{(f)}−n_{3,l}^{(f}^{ₗ}^{*)})mod N₃, such that n_{3,l}^{(f}^{ₗ}^{*)}=0, after remapping. The index f is remapped with respect to fₗ* as f=(f−fₗ*) mod Mᵤ, such that the index of the strongest coefficient is fₗ*=0 (l=1, . . . , u), after remapping. The indices of i_{2,4,l}, i_{2,5,l} and i_{1,7,l} indicate amplitude coefficients, phase coefficients and bitmap after remapping.

The strongest coefficient of layer l is identified by i_{1,8,l}∈{0,1, . . . ,2L−1}, which is obtained as follows:

$${i}_{1 , 8 , l} = \{ \begin{matrix}{\sum }_{i = 0}^{{i}_{1}^{*}} {k}_{1 , i , 0}^{( 3 )} - 1 & v = 1 \\ {i}_{1}^{*} & 1 < v \leq 4\end{matrix} ,$$

for l=1, . . . , u.

TABLE 9
Mapping of elements of i_{2,3,l}: k_{l,p}⁽¹⁾ to p_{l,p}⁽¹⁾

| k_{l,p}⁽¹⁾ | p_{l,p}⁽¹⁾ |
|---|---|
| 0 | Reserved |
| 1 | $\frac{1}{\sqrt{128}}$ |
| 2 | ${( \frac{1}{8192} )}^{1 / 4}$ |
| 3 | $\frac{1}{8}$ |
| 4 | ${( \frac{1}{2048} )}^{1 / 4}$ |
| 5 | $\frac{1}{2 \sqrt{8}}$ |
| 6 | ${( \frac{1}{512} )}^{1 / 4}$ |
| 7 | $\frac{1}{4}$ |
| 8 | ${( \frac{1}{128} )}^{1 / 4}$ |
| 9 | $\frac{1}{\sqrt{8}}$ |
| 10 | ${( \frac{1}{32} )}^{1 / 4}$ |
| 11 | $\frac{1}{2}$ |
| 12 | ${( \frac{1}{8} )}^{1 / 4}$ |
| 13 | $\frac{1}{\sqrt{2}}$ |
| 14 | ${( \frac{1}{2} )}^{1 / 4}$ |
| 15 | 1 |

The amplitude and phase coefficient indicators are reported as follows:

$${k}_{l , ⌊ \frac{{i}_{l}^{*}}{L} ⌋}^{( 1 )} = 15 , {k}_{l , {i}_{l}^{*} , 0}^{( 2 )} = 7 , {k}_{l , {i}_{l}^{*} , 0}^{( 3 )} = 1$$

and c_{l,i}_{ₗ}_{*,0}=0 (l=1, . . . , u). The indicators

$${k}_{l , ⌊ \frac{{i}_{l}^{*}}{L} ⌋}^{( 1 )} , {k}_{l , {i}_{l}^{*} , 0}^{( 2 )}$$

and c_{l,i}_{ₗ}_{*,0} are not reported for l=1, . . . , u.

The indicator

$${k}_{l , ( ⌊ \frac{{i}_{l}^{*}}{L} ⌋ + 1 ) mod 2}^{( 1 )}$$

is reported for l=1, . . . , u.

The K^{NZ}−u indicators k_{l,i,f}⁽²⁾ for which k_{l,i,f}⁽³⁾=1, i≠iₗ*, f≠0 are reported.

The K^{NZ}−u indicators c_{l,i,f} for which k_{l,i,f}⁽³⁾=1, i≠iₗ*, f≠0 are reported.

The remaining 2L·Mᵥ·v−K^{NZ} indicators k_{l,i,f}⁽²⁾ are not reported.

The remaining 2L·Mᵥ·v−K^{NZ} indicators c_{l,i,f} are not reported.

TABLE 10
Mapping of elements of i_{2,4,l}: k_{l,i,f}⁽²⁾ to p_{l,i,f}⁽²⁾

| k_{l,i,f}⁽²⁾ | p_{l,i,f}⁽²⁾ |
|---|---|
| 0 | $\frac{1}{8 \sqrt{2}}$ |
| 1 | $\frac{1}{8}$ |
| 2 | $\frac{1}{4 \sqrt{2}}$ |
| 3 | $\frac{1}{4}$ |
| 4 | $\frac{1}{2 \sqrt{2}}$ |
| 5 | $\frac{1}{2}$ |
| 6 | $\frac{1}{\sqrt{2}}$ |
| 7 | 1 |

The elements of n₁ and n₂ are found from i_{1,2} using the algorithm described in 5.2.2.2.3, where the values of C(x,y) are given in Table 11.

For N₃>19, Mᵢₙᵢₜᵢₐₗ is identified by i_{1,5}.

For all values of N₃, n_{3,l}⁽⁰⁾=0 for l=1, . . . , u. If Mᵤ>1, the nonzero elements of n_{3,l}, identified by n_{3,l}⁽¹⁾, . . . ,n_{3,l}^{(M}^{ᵤ}⁻¹⁾, are found from i_{1,6,l} (l=1, . . . , u), for N₃≤19, and from i_{1,6,l} (l=1, . . . , u) and Mᵢₙᵢₜᵢₐₗ, for N₃>19, using C(x,y) as defined in Table 11 and the algorithm:
s₀=0,
for f=1, . . . , Mᵤ−1.

Find the largest x*∈{Mᵤ−1−f, . . . , N₃−1−f} in Table 11 such that:

$${i}_{1 , 6 , l} - {s}_{f - 1} \geq C ( {x}^{*} , {M}_{υ} - f )$$

$${e}_{f} = C ( {x}^{*} , {M}_{υ} - f )$$

$${s}_{f} = {s}_{f - 1} + {e}_{f}$$

### if N₃≤19

$${n}_{3 , l}^{( f )} = {N}_{3} - 1 - {x}^{*}$$

else

$${n}_{l}^{( f )} = 2 {M}_{υ} - 1 - {x}^{*}$$

$$if {n}_{l}^{( f )} \leq {M}_{initiαl} + 2 {M}_{υ} - 1$$

$${n}_{3 , l}^{( f )} = {n}_{l}^{( f )}$$

else

$${n}_{3 , l}^{( f )} = {n}_{l}^{( f )} + ( {N}_{3} - 2 {M}_{υ} )$$

TABLE 9
Combinatorial coefficients C(x, y)

| | y | | | | | | | | |
|---|---|---|---|---|---|---|---|---|---|
| x | 1 | 2 | 3 | 4 | 5 | 6 | 7 | 8 | 9 |
| 0 | 0 | 0 | 0 | 0 | 0 | 0 | 0 | 0 | 0 |
| 1 | 1 | 0 | 0 | 0 | 0 | 0 | 0 | 0 | 0 |
| 2 | 2 | 1 | 0 | 0 | 0 | 0 | 0 | 0 | 0 |
| 3 | 3 | 3 | 1 | 0 | 0 | 0 | 0 | 0 | 0 |
| 4 | 4 | 6 | 4 | 1 | 0 | 0 | 0 | 0 | 0 |
| 5 | 5 | 10 | 10 | 5 | 1 | 0 | 0 | 0 | 0 |
| 6 | 6 | 15 | 20 | 15 | 6 | 1 | 0 | 0 | 0 |
| 7 | 7 | 21 | 35 | 35 | 21 | 7 | 1 | 0 | 0 |
| 8 | 8 | 28 | 56 | 70 | 56 | 28 | 8 | 1 | 0 |
| 9 | 9 | 36 | 84 | 126 | 126 | 84 | 36 | 9 | 1 |
| 10 | 10 | 45 | 120 | 210 | 252 | 210 | 120 | 45 | 10 |
| 11 | 11 | 55 | 165 | 330 | 462 | 462 | 330 | 165 | 55 |
| 12 | 12 | 66 | 220 | 495 | 792 | 924 | 792 | 495 | 220 |
| 13 | 13 | 78 | 286 | 715 | 1287 | 1716 | 1716 | 1287 | 715 |
| 14 | 14 | 91 | 364 | 1001 | 2002 | 3003 | 3432 | 3003 | 2002 |
| 15 | 15 | 105 | 455 | 1365 | 3003 | 5005 | 6435 | 6435 | 5005 |
| 16 | 16 | 120 | 560 | 1820 | 4368 | 8008 | 11440 | 12870 | 11440 |
| 17 | 17 | 136 | 680 | 2380 | 6188 | 12376 | 19448 | 24310 | 24310 |
| 18 | 18 | 153 | 816 | 3060 | 8568 | 18564 | 31824 | 43758 | 48620 |

When n_{3,l} and Mᵢₙᵢₜᵢₐₗ are known, i_{1,5} and i_{1,6,l} (l=1, . . . , u) are found as follows:

If N₃≤19, i_{1,5}=0 and is not reported. If Mᵥ=1, i_{1,6,l}=0, for l=1, . . . , v, and is not reported. If Mᵥ>1, i_{1,6,l}=Σ_{f=1}^{M}^{ᵤ}⁻¹C(N₃−1−n_{3,l}^{(f)},Mᵤ−f), where C(x,y) is given in Table 11 and where the indices f=1, . . . , Mᵤ−1 are assigned such that n_{3,l}^{(f)} increases as f increases.

If N₃>19, Mᵢₙᵢₜᵢₐₗ is indicated by i_{1,5}, which is reported and given by:

$${i}_{1 , 5} = \{ \begin{matrix}{M}_{initial} & {M}_{initial} = 0 \\ {M}_{initial} + 2 {M}_{υ} & {M}_{initial} < 0\end{matrix} .$$

Only the nonzero indices n_{3,l}^{(f)}∈IntS, where IntS={Mᵢₙᵢₜᵢₐₗ+i) mod N₃, i=0,1, . . . ,2Mᵤ−1}, are reported, where the indices f=1, . . . , Mᵤ−1 are assigned such that n_{3,l}^{(f)} increases as f increases. Let:

$${n}_{l}^{( f )} = \{ \begin{matrix}{n}_{3 , l}^{( f )} & {n}_{3 , l}^{( f )} \leq {M}_{initial} + 2 {M}_{υ} - 1 \\ {n}_{3 , l}^{( f )} - ( {N}_{3} - 2 {M}_{υ} ) & {n}_{3 , l}^{( f )} > {M}_{initial} + {N}_{3} - 1\end{matrix} ,$$

then i_{1,6,l}=Σ_{f=1}^{M}^{ᵤ}⁻⁻¹C(2Mᵤ−1−nₗ^{(f)},Mᵤ−f), where C(x,y) is given in Table 12.

The codebooks for 1-4 layers are given in Table 12, where m₁⁽ⁱ⁾, m₂⁽ⁱ⁾, for i=0,1, . . . , L−1, vₘ_{₁}_{⁽ⁱ⁾}_{,m}_{₂}_{⁽ⁱ⁾}, and the quantities φ_{l,i,f} and y_{t,l} are given by:

$${φ}_{l , i , f} = {e}^{j \frac{2 π {c}_{l , i , f}}{16}} ,$$

$${y}_{t , l} = [ \begin{matrix}{y}_{t , l}^{( 0 )} & {y}_{t , l}^{( 1 )} & … & {y}_{t , l}^{( {M}_{υ} - 1 )}\end{matrix} ] ,$$

where t={0,1, . . . , N₃−1}, is the index associated with the precoding matrix, l={1, . . . , u}, and with:

$${y}_{t , l}^{( f )} = {e}^{j \frac{2 π {tn}_{3 , l}^{( f )}}{{N}_{3}}} ,$$

for f=0,1, . . . ,Mᵤ−1.

TABLE 10
Codebook for 1-layer. 2-layer, 3-layer and 4-layer CSI reporting using antenna ports 3000 to 2999 + PCSI-RS

| Layers | |
|---|---|
| υ = 1 | W_{q}_{₁}_{,q}_{₂}_{,n}_{₁}_{,n}_{₂}_{,n}_{_{3,1}}_{,p}_{₁}_{⁽¹⁾}_{,p}_{₁}_{⁽²⁾}_{,i}_{_{2,5,1}}_{,t}⁽¹⁾ = W_{q}_{₁}_{,q}_{₂}_{,n}_{₁}_{,n}_{₂}_{,n}_{_{3,1}}_{,p}_{₁}_{⁽¹⁾}_{,p}_{₁}_{⁽²⁾}_{,i}_{_{2,5,1}}_{,t}¹ |
| υ = 2 | ${W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , t}^{( 2 )} = \frac{1}{\sqrt{2}} [ \begin{matrix}{W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , t}^{1} & {W}_{{q}_{1} , {q}_{2} , {n}_{1} , {n}_{2} , {n}_{3 , 2} , {p}_{2}^{( 1 )} , {p}_{2}^{( 2 )} , {i}_{2 , 5 , 2} , t}^{2}\end{matrix} ]$ |
| υ = 3 | $\text{} \begin{matrix}{W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , {n}_{3 , 3} , {p}_{3}^{( 1 )} , {p}_{3}^{( 2 )} , {i}_{2 , 5 , 3} , t}^{( 3 )} = \\ \frac{1}{\sqrt{3}} [ \begin{matrix}{W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , t}^{1} & \begin{matrix}{W}_{{q}_{1} , {q}_{2} , {n}_{1} , {n}_{2} , {n}_{3 , 2} , {p}_{2}^{( 1 )} , {p}_{2}^{( 2 )} , {i}_{2 , 5 , 2} , t}^{2} & {W}_{{q}_{1} , {q}_{2} , {n}_{1} , {n}_{2} , {n}_{3 , 3} , {p}_{3}^{( 1 )} , {p}_{3}^{( 2 )} , {i}_{2 , 5 , 3} , t}^{3}\end{matrix}\end{matrix} ]\end{matrix}$ |
| υ = 4 | $\text{} \begin{matrix}{W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , {n}_{3 , 3} , {p}_{3}^{( 1 )} , {p}_{3}^{( 2 )} , {i}_{2 , 5 , 3} , {n}_{3 , 4} , {p}_{4}^{( 1 )} , {p}_{4}^{( 2 )} , {i}_{2 , 5 , 4} , t}^{( 4 )} = \\ \frac{1}{2} [ \begin{matrix}{W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , t}^{1} & \begin{matrix}{W}_{{q}_{1} , {q}_{2} , {n}_{1} , {n}_{2} , {n}_{3 , 2} , {p}_{2}^{( 1 )} , {p}_{2}^{( 2 )} , {i}_{2 , 5 , 2} , t}^{2} & {W}_{{q}_{1} , {q}_{2} , {n}_{1} , {n}_{2} , {n}_{3 , 3} , {p}_{3}^{( 1 )} , {p}_{3}^{( 2 )} , {i}_{2 , 5 , 3} , t}^{3} & {W}_{{q}_{1} , {q}_{2} , {n}_{1} , {n}_{2} , {n}_{3 , 4} , {p}_{4}^{( 1 )} , {p}_{4}^{( 2 )} , {i}_{2 , 5 , 4} , t}^{4}\end{matrix}\end{matrix} ]\end{matrix}$ |

$Where {W}_{{q}_{1} , {q}_{2} , {n}_{1} , {n}_{2} , {n}_{3} , {p}_{l}^{( 1 )} , {p}_{l}^{( 2 )} , {i}_{2 , 5 , l} , t}^{l} = \frac{1}{\sqrt{{N}_{1} {N}_{2} {γ}_{t , l}}} [ \begin{matrix}{\sum }_{i = 0}^{L - 1} {v}_{{m}_{1}^{( i )} , {m}_{2}^{( i )}} {p}_{l , 0}^{( 1 )} {\sum }_{f = 0}^{{M}_{υ} - 1} {y}_{t , l}^{( f )} {p}_{l , i , f}^{( 2 )} {φ}_{l , i , f} \\ {\sum }_{i = 0}^{L - 1} {v}_{{m}_{1}^{( i )} , {m}_{2}^{( i )}} {p}_{l , 1}^{( 1 )} {\sum }_{f = 0}^{{M}_{υ} - 1} {y}_{t , l}^{( f )} {p}_{l , i + L , f}^{( 2 )} {φ}_{l , i + L , f}\end{matrix} ] , l = 1 , 2 , 3 , 4 ,$
${γ}_{t , l} = {\sum }_{i = 0}^{2 L - 1} {( {p}_{l , ⌊ \frac{i}{L} ⌋}^{( 1 )} )}^{2} {\vert {\sum }_{f = 0}^{{M}_{υ} - 1} {y}_{t , l}^{( f )} {p}_{l , i , f}^{( 2 )} {φ}_{l , i , f} \vert}^{2} and the mappings from {i}_{1} to {q}_{1} , {q}_{2} , {n}_{1} , {n}_{2} , {n}_{3 , 1} , {n}_{3 , 2} , {n}_{3 , 3} , {n}_{3 , 4} , and from {i}_{2} to {i}_{2 , 5 , 1} , {i}_{2 , 5 , 2} , {i}_{2 , 5 , 3} ,$
i_{2,5,4}, p₁⁽¹⁾, p₂⁽¹⁾, p₃⁽¹⁾ and p₄⁽¹⁾, p₁⁽²⁾, p₂⁽²⁾, p₃⁽²⁾ and p₄⁽²⁾ are as described above, including the ranges of the constituent indices of i₁
and i₂.

For coefficients with k_{l,i,f}⁽³⁾=0, amplitude and phase are set to zero, i.e., p_{l,i,f}⁽²⁾=0 and φ_{l,i,f}=0.

The bitmap parameter typeII-RI-Restriction-r16 forms the bit sequence r₃, r₂, r₁, r₀ where r₀ is the LSB and r₃ is the MSB. When rᵢ is zero, i∈{0,1, . . . ,3}, PMI and RI reporting are not allowed to correspond to any precoder associated with u=i+1 layers.

The bitmap parameter n1−n2-codebookSubsetRestriction-r16 forms the bit sequence B=B₁B₂ and configures the vector group indices g^{(k)}. Bits b₂^{(k,2(N}^{₁}^{x}^{₂}^{+x}^{₁}⁾⁺¹⁾b₂^{(k,2(N}^{₁}^{x}^{₂}^{+x}^{₁}⁾⁾ indicate the maximum allowed average amplitude, γ_{i+pL} (p=0,1), with i∈{0,1, . . . , L−1}, of the coefficients associated with the vector in group g^{(k)} indexed by x₁, x₂, where the maximum amplitudes are given in Table 13 and the average coefficient amplitude is restricted as follows:

$$\sqrt{\frac{1}{{Σ}_{f = 0}^{{M}_{υ} - 1} {κ}_{l , i + pL , f}^{( 3 )}} {Σ}_{f = 0}^{{M}_{υ} - 1} {{k}_{l , i + pL , f}^{( 3 )} ( {p}_{l , p}^{( 1 )} {p}_{l , i + pL , f}^{( 2 )} )}^{2}} \leq {γ}_{i + pL} ,$$

for l=1, . . . , u, and p=0,1. A UE that does not report the parameter amplitudeSubsetRestriction=‘supported’ in its capability signaling is not expected to be configured with b₂^{(k,2(N}^{₁}^{x}^{₂}^{+x}^{₁}⁾⁺¹⁾b₂^{(k,2(N}^{₁}^{x}^{₂}^{+x}^{₁}⁾⁾=01 or 10.

TABLE 11
Maximum allowed average coefficient
amplitudes for restricted vectors

| | Maximum |
|---|---|
| | Average |
| Bit | Coefficient |
| b₂^{(k, 2(N}^{₁}^{x}₂ + ^{x}^{₁}⁾ + ¹⁾ | Amplitude |
| b₂^{(k, 2(N}^{₁}^{x}₂ + ^{x}^{₁}⁾⁾ | γ_{i+pL} |
| 00 | 0 |
| 01 | \sqrt{¼} |
| 10 | \sqrt{½} |
| 11 | 1 |

In some embodiments, there may be an NR Type-II port selection codebook. For Type-II port selection codebook, only K (where K≤2N₁N₂) beamformed CSI-RS ports are utilized in DL transmission, in order to reduce complexity. The KxN3 codebook matrix per layer takes on the form: W=W₁^{PS}\tilde{W}₂W_{f}^{H}. Here, \tilde{W}₂ and W₃ follow the same structure as the conventional NR Rel. 16 Type-II Codebook, where both are layer specific. The matrix W₁^{PS} is a Kx2L block-diagonal matrix with the same structure as that in the NR Type-II port selection codebook.

In more detail, Type-II port selection codebook is as follows:

For 4 antenna ports {3000, 3001, . . . , 3003}, 8 antenna ports {3000, 3001, . . . , 3007}, 12 antenna ports {3000, 3001, . . . , 3011}, 16 antenna ports {3000, 3001, . . . , 3015}, 24 antenna ports {3000, 3001, . . . , 3023}, and 32 antenna ports {3000, 3001, . . . , 3031}, and the UE configured with higher layer parameter codebookType set to ‘typeII-PortSelection-r16’.

The number of CSI-RS ports is configured.

The value of d is configured with the higher layer parameter portSelectionSamplingSize-r16, where d∈{1,2,3,4} and d≤L.

The values L, β and pᵤ are configured, where the supported configurations are given in Table 14.

TABLE 12
Codebook parameter configurations for L, β andpᵥ

| | |
|---|---|
| paramCombination- | pᵥ |

| r16 | L | v ∈ {1, 2} | v ∈ {3, 4} | β |
|---|---|---|---|---|
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |

The UE shall report the RI value v according to the configured higher layer parameter typeII-PortSelectionRI-Restriction-r16. The UE shall not report u>4.

The values of R is configured.

The UE is also configured with the higher layer bitmap parameter typeII-PortSelectionRI-Restriction-r16, which forms the bit sequence r₃, r₂, r₁, r₀, where r₀ is the LSB and r₃ is the MSB. When rᵢ is zero, i∈{0,1, . . . , 3}, PMI and RI reporting are not allowed to correspond to any precoder associated with u=i+1 layers.

The PMI value corresponds to the codebook indices i₁ and i₂ where:

$${i}_{1} = \{ \begin{matrix}[ \begin{matrix}\begin{matrix}\begin{matrix}\begin{matrix}{i}_{1 , 1} & {i}_{1 , 5}\end{matrix} & {i}_{1 , 6 , 1}\end{matrix} & {i}_{1 , 7 , 1}\end{matrix} & {i}_{1 , 8 , 1}\end{matrix} ] \\ [ \begin{matrix}\begin{matrix}\begin{matrix}\begin{matrix}{i}_{1 , 1} & {i}_{1 , 5}\end{matrix} & {i}_{1 , 6 , 1}\end{matrix} & {i}_{1 , 7 , 1}\end{matrix} & {i}_{1 , 8 , 1} & {i}_{1 , 6 , 2} & {i}_{1 , 7 , 2} & {i}_{1 , 8 , 2}\end{matrix} ] \\ [ \begin{matrix}\begin{matrix}\begin{matrix}\begin{matrix}{i}_{1 , 1} & {i}_{1 , 5}\end{matrix} & {i}_{1 , 6 , 1}\end{matrix} & {i}_{1 , 7 , 1}\end{matrix} & {i}_{1 , 8 , 1} & {i}_{1 , 6 , 2} & {i}_{1 , 7 , 2} & {i}_{1 , 8 , 2} & {i}_{1 , 6 , 3} & {i}_{1 , 7 , 3} & {i}_{1 , 8 , 3}\end{matrix} ] \\ [ \begin{matrix}\begin{matrix}\begin{matrix}\begin{matrix}{i}_{1 , 1} & {i}_{1 , 5}\end{matrix} & {i}_{1 , 6 , 1}\end{matrix} & {i}_{1 , 7 , 1}\end{matrix} & {i}_{1 , 8 , 1} & {i}_{1 , 6 , 2} & {i}_{1 , 7 , 2} & {i}_{1 , 8 , 2} & {i}_{1 , 6 , 3} & {i}_{1 , 7 , 3} & {i}_{1 , 8 , 3} & {i}_{1 , 6 , 4} & {i}_{1 , 7 , 4} & {i}_{1 , 8 , 4}\end{matrix} ]\end{matrix}$$

$${i}_{2} = \{ \begin{matrix}[ \begin{matrix}\begin{matrix}{i}_{2 , 3 , 1} & {i}_{2 , 4 , 1}\end{matrix} & {i}_{2 , 5 , 1}\end{matrix} ] \\ [ \begin{matrix}\begin{matrix}{i}_{2 , 3 , 1} & {i}_{2 , 4 , 1}\end{matrix} & {i}_{2 , 5 , 1} & {i}_{2 , 3 , 2} & {i}_{2 , 4 , 2} & {i}_{2 , 5 , 2}\end{matrix} ] \\ [ \begin{matrix}\begin{matrix}{i}_{2 , 3 , 1} & {i}_{2 , 4 , 1}\end{matrix} & {i}_{2 , 5 , 1} & {i}_{2 , 3 , 2} & {i}_{2 , 4 , 2} & {i}_{2 , 5 , 2} & {i}_{2 , 3 , 3} & {i}_{2 , 4 , 3} & {i}_{2 , 5 , 3}\end{matrix} ] \\ [ \begin{matrix}\begin{matrix}{i}_{2 , 3 , 1} & {i}_{2 , 4 , 1}\end{matrix} & {i}_{2 , 5 , 1} & {i}_{2 , 3 , 2} & {i}_{2 , 4 , 2} & {i}_{2 , 5 , 2} & {i}_{2 , 3 , 3} & {i}_{2 , 4 , 3} & {i}_{2 , 5 , 3} & {i}_{2 , 3 , 4} & {i}_{2 , 4 , 4} & {i}_{2 , 5 , 4}\end{matrix} ]\end{matrix}$$

The 2L antenna ports are selected by the index i_{1,1}.

Parameters N₃, Mᵤ, Mᵢₙᵢₜᵢₐₗ (for N₃>19) and K₀ are defined.

For layer l, l=1, . . . , u, the strongest coefficient i_{1,8,l}, the amplitude coefficient indicators i_{2,3,l} and i_{2,4,l}, the phase coefficient indicator i_{2,5,l} and the bitmap indicator i_{1,7,l} are defined and indicated, where the mapping from k_{l,p}⁽¹⁾ to the amplitude coefficient p_{l,p}⁽¹⁾ is given and the mapping from k_{l,i,f}⁽²⁾ to the amplitude coefficient p_{l,i,f}⁽²⁾ is given.

The number of nonzero coefficients for layer l, Kₗ^{NZ}, and the total number of nonzero coefficients K^{NZ} are defined.

The amplitude coefficients pₗ⁽¹⁾ and pₗ⁽²⁾ (l=1, . . . , u) are represented.

The amplitude and phase coefficient indicators are reported.

Codebook indicators i_{1,5} and i_{1,6,l} (l=1, . . . , u) are found.

The codebooks for 1-4 layers are given in Table 15, where vₘ is a P_{CSI-RS}/2-element column vector containing a value of 1 in element (m mod P_{CSI-RS}/2) and zeros elsewhere (where the first element is element 0), and the quantities φ_{l,i,f} and y_{t,l} are defined.

TABLE 13
Codebook for 1-layer. 2-layer, 3-layer and 4-layer CSI reporting using antenna ports 3000 to 2999 + PCSI-RS

| Layers | |
|---|---|
| υ = 1 | Wᵢ_{_{1,1}}_{,n}_{_{3,1}}_{,p}_{₁}_{⁽¹⁾}_{,p}_{₁}_{⁽²⁾}_{,i}_{_{2,5,1}}_{,t}⁽¹⁾ = Wᵢ_{_{1,1}}_{,n}_{_{3,1}}_{,p}_{₁}_{⁽¹⁾}_{,p}_{₁}_{⁽²⁾}_{,i}_{_{2,5,1}}_{,t}¹ |
| υ = 2 | ${W}_{{i}_{1 , 1} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , t}^{( 2 )} = \frac{1}{\sqrt{2}} [ \begin{matrix}{W}_{{i}_{1 , 1} , {n}_{3 , 1} , {p}_{1}^{( 1 )} , {p}_{1}^{( 2 )} , {i}_{2 , 5 , 1} , t}^{1} & {W}_{{i}_{1 , 1} , {n}_{3 , 2} , {p}_{2}^{( 1 )} , {p}_{2}^{( 2 )} , {i}_{2 , 5 , 2} , t}^{2}\end{matrix} ]$ |
| υ = 3 | $\text{} \begin{matrix}{W}_{{i}_{1 , 1} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , {n}_{3 , 3} , {p}_{3}^{( 1 )} , {p}_{3}^{( 2 )} , {i}_{2 , 5 , 3} , t}^{( 3 )} = \\ \frac{1}{\sqrt{3}} [ \begin{matrix}{W}_{{i}_{1 , 1} , {n}_{3 , 1} , {p}_{1}^{( 1 )} , {p}_{1}^{( 2 )} , {i}_{2 , 5 , 1} , t}^{1} & \begin{matrix}{W}_{{i}_{1 , 1} , {n}_{3 , 2} , {p}_{2}^{( 1 )} , {p}_{2}^{( 2 )} , {i}_{2 , 5 , 2} , t}^{2} & {W}_{{i}_{1 , 1} , {n}_{3 , 3} , {p}_{3}^{( 1 )} , {p}_{3}^{( 2 )} , {i}_{2 , 5 , 3} , t}^{3}\end{matrix}\end{matrix} ]\end{matrix}$ |
| υ = 4 | $\text{} \begin{matrix}{W}_{{i}_{1 , 1} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , {n}_{3 , 3} , {p}_{3}^{( 1 )} , {p}_{3}^{( 2 )} , {i}_{2 , 5 , 3} , {n}_{3 , 4} , {p}_{4}^{( 1 )} , {p}_{4}^{( 2 )} , {i}_{2 , 5 , 4} , t}^{( 4 )} = \\ \frac{1}{2} [ \begin{matrix}{W}_{{i}_{1 , 1} , {n}_{3 , 1} , {p}_{1}^{( 1 )} , {p}_{1}^{( 2 )} , {i}_{2 , 5 , 1} , t}^{1} & \begin{matrix}{W}_{{i}_{1 , 1} , {n}_{3 , 2} , {p}_{2}^{( 1 )} , {p}_{2}^{( 2 )} , {i}_{2 , 5 , 2} , t}^{2} & {W}_{{i}_{1 , 1} , {n}_{3 , 3} , {p}_{3}^{( 1 )} , {p}_{3}^{( 2 )} , {i}_{2 , 5 , 3} , t}^{3} & {W}_{{i}_{1 , 1} , {n}_{3 , 4} , {p}_{4}^{( 1 )} , {p}_{4}^{( 2 )} , {i}_{2 , 5 , 4} , t}^{4}\end{matrix}\end{matrix} ]\end{matrix}$ |

$Where {W}_{{i}_{1 , 1} , {n}_{3} , {p}_{l}^{( 1 )} , {p}_{l}^{( 2 )} , {i}_{2 , 5 , l} , t}^{l} = \frac{1}{\sqrt{{γ}_{t , l}}} [ \begin{matrix}{\sum }_{i = 0}^{L - 1} {v}_{{i}_{1 , 1} d + i} {p}_{l , 0}^{( 1 )} {\sum }_{f = 0}^{{M}_{υ} - 1} {y}_{t , l}^{( f )} {p}_{l , i , f}^{( 2 )} {φ}_{l , i , f} \\ {\sum }_{i = 0}^{L - 1} {v}_{{i}_{1 , 1} d + i} {p}_{l , 1}^{( 1 )} {\sum }_{f = 0}^{{M}_{υ} - 1} {y}_{t , l}^{( f )} {p}_{l , i + L , f}^{( 2 )} {φ}_{l , i + L , f}\end{matrix} ] , l = 1 , 2 , 3 , 4 ,$
${γ}_{t , l} = {\sum }_{i = 0}^{2 L - 1} {( {p}_{l , ⌊ \frac{i}{L} ⌋}^{( 1 )} )}^{2} {\vert {\sum }_{f = 0}^{{M}_{υ} - 1} {y}_{t , l}^{( f )} {p}_{l , i , f}^{( 2 )} {φ}_{l , i , f} \vert}^{2} and the mappings from {i}_{1} to {i}_{1 , 1} , {n}_{3 , 1} , {n}_{3 , 2} , {n}_{3 , 3} , {n}_{3 , 4} , and from {i}_{2} to {i}_{2 , 5 , 1} ,$
i_{2,5,2}, i_{2,5,3}, i_{2,5,4}, p₁⁽¹⁾, p₂⁽¹⁾, p₃⁽¹⁾ and p₄⁽¹⁾, p₁⁽²⁾, p₂⁽²⁾, p₃⁽²⁾ and p₄⁽²⁾ are as described above, including the
ranges of the constituent indices of i₁ and i₂.

For coefficients with k_{l,i,f}⁽³⁾=0, amplitude and phase are set to zero, i.e., p_{l,i,f}⁽²⁾=0 and φ_{l,i,f}=0.

In certain embodiments, two transmission modes exist for precoded PUSCH transmission: codebook-based transmission and non-codebook-based transmission. A summary describing both modes is provided herein.

For codebook based transmission (e.g., UL), PUSCH can be scheduled by DCI format 0_0, DCI format 0_1, DCI format 0_2 or semi-statically configured to operate. If this PUSCH is scheduled by DCI format 0_1, DCI format 0_2, or semi-statically configured to operate, the UE determines its PUSCH transmission precoder based on SRI, TPMI, and the transmission rank, where the SRI, TPMI and the transmission rank are given by DCI fields of SRS resource indicator and precoding information and number of layers for DCI format 0_1 and 0_2 or given by srs-ResourceIndicator and precodingAndNumberOfLayers. The SRS-ResourceSet(s) applicable for PUSCH scheduled by DCI format 0_1 and DCI format 0_2 are defined by the entries of the higher layer parameter srs-Resource SetToAddModList and srs-ResourceSetToAddModListForDCI-Format0-2-r16 in SRS-config, respectively. The TPMI is used to indicate the precoder to be applied over the layers {0 . . . v−1} and that corresponds to the SRS resource selected by the SRI when multiple SRS resources are configured, or if a single SRS resource is configured TPMI is used to indicate the precoder to be applied over the layers {0 . . . v−1} and that corresponds to the SRS resource. The transmission precoder is selected from the uplink codebook that has a number of antenna ports equal to higher layer parameter nrofSRS-Ports in SRS-Config. When the UE is configured with the higher layer parameter txConfig set to ‘codebook’, the UE is configured with at least one SRS resource. The indicated SRI in slot n is associated with the most recent transmission of SRS resource identified by the SRI, where the SRS resource is prior to the PDCCH carrying the SRI.

For codebook based transmission, the UE determines its codebook subsets based on TPMI and upon the reception of higher layer parameter codebookSubset in pusch-Config for PUSCH associated with DCI format 0_1 and codebookSubsetForDCI-Format0-2-r16 in pusch-Config for PUSCH associated with DCI format 0_2 which may be configured with ‘fully AndPartialAndNonCoherent’, or ‘partialAndNonCoherent’, or ‘nonCoherent’ depending on the UE capability. When higher layer parameter ul-FullPowerTransmission-r16 is set to ‘fullpowerMode2’ and the higher layer parameter codebookSubset or the higher layer parameter codebookSubsetForDCI-Format0-2-r16 is set to ‘partialAndNonCoherent’, and when the SRS-resourceSet with usage set to “codebook” includes at least one SRS resource with 4 ports and one SRS resource with 2 ports, the codebookSubset associated with the 2-port SRS resource is ‘nonCoherent’. The maximum transmission rank may be configured by the higher layer parameter maxRank in pusch-Config for PUSCH scheduled with DCI format 0_1 and maxRank-ForDCIFormat0_2 for PUSCH scheduled with DCI format 0_2.

A UE reporting its UE capability of ‘partialAndNonCoherent’ transmission shall not expect to be configured by either codebook Subset or codebookSubsetForDCI-Format0-2-r16 with ‘fully AndPartialAndNonCoherent’.

A UE reporting its UE capability of ‘nonCoherent’ transmission shall not expect to be configured by either codebookSubset or codebookSubsetForDCI-Format0-2-r16 with ‘fully AndPartialAndNonCoherent’ or with ‘partialAndNonCoherent’.

A UE shall not expect to be configured with the higher layer parameter codebookSubset or the higher layer parameter codebookSubsetForDCI-Format0-2-r16 set to ‘partialAndNonCoherent’ when higher layer parameter nrofSRS-Ports in an SRS-ResourceSet with usage set to ‘codebook’ indicates that the maximum number of the configured SRS antenna ports in the SRS-ResourceSet is two.

For codebook based transmission, the UE may be configured with a single SRS-ResourceSet with usage set to ‘codebook’ and only one SRS resource can be indicated based on the SRI from within the SRS resource set. Except when higher layer parameter ul-FullPowerTransmission-r16 is set to ‘fullpowerMode2’, the maximum number of configured SRS resources for codebook based transmission is 2. If aperiodic SRS is configured for a UE, the SRS request field in DCI triggers the transmission of aperiodic SRS resources.

A UE shall not expect to be configured with higher layer parameter ul-FullPowerTransmission-r16 set to ‘fullpowerMode1’ and codebookSubset or codebookSubsetForDCI-Format0-2-r16 set to ‘fullAndPartialAndNonCoherent’ simultaneously.

The UE shall transmit PUSCH using the same antenna port(s) as the SRS port(s) in the SRS resource indicated by the DCI format 0_1 or 0_2 or by configuredGrantConfig.

The DM-RS antenna ports {\tilde{p}₀, . . . ,\tilde{p}ᵤ₋₁} are determined according to the ordering of DM-RS port(s).

Except when higher layer parameter ul-FullPowerTransmission-r16 is set to ‘fullpowerMode2’, when multiple SRS resources are configured by SRS-ResourceSet with usage set to ‘codebook’, the UE shall expect that higher layer parameters nrofSRS-Ports in SRS-Resource in SRS-ResourceSet shall be configured with the same value for all these SRS resources.

When higher layer parameter ul-FullPowerTransmission-r16 is set to ‘fullpowerMode2’, the UE can be configured with one SRS resource or multiple SRS resources with same or different number of SRS ports within an SRS resource set with usage set to ‘codebook’.

Up to 2 different spatial relations can be configured for all SRS resources in the SRS resource set with usage set to ‘codebook’ when multiple SRS resources are configured in the SRS resource set.

Subject to UE capability, a maximum of 2 or 4 SRS resources are supported in an SRS resource set with usage set to ‘codebook’.

In certain embodiments, there may be a DCI Format 0_1:
1) precoding information and number of layers-number of bits determined by the following:
a) 0 bits if the higher layer parameter txConfig=nonCodeBook;
b) 0 bits for 1 antenna port and if the higher layer parameter txConfig=codebook;
c) 4, 5, or 6 bits for 4 antenna ports, if txConfig=codebook, ul-FullPowerTransmission-r16 is not configured or configured to fullpowerMode2 or configured to fullpower, and according to whether transform precoder is enabled or disabled, and the values of higher layer parameters maxRank, and codebook Subset;
d) 4 or 5 bits for 4 antenna ports, if txConfig=codebook, ul-FullPowerTransmission-r16=fullpowerMode1, maxRank=2, transform precoder is disabled, and according to the values of higher layer parameter codebookSubset;
e) 4 or 6 bits for 4 antenna ports, if txConfig=codebook, ul-FullPowerTransmission-r16=fullpowerMode1, maxRank-3 or 4, transform precoder is disabled, and according to the values of higher layer parameter codebookSubset;
f) 2, 4, or 5 bits for 4 antenna ports, if txConfig=codebook, ul-FullPowerTransmission-r16 is not configured or configured to fullpowerMode2 or configured to fullpower, and according to whether transform precoder is enabled or disabled, and the values of higher layer parameters maxRank, and codebookSubset;
g) 3 or 4 bits for 4 antenna ports, if txConfig=codebook, ul-FullPowerTransmission-r16=fullpowerMode1, maxRank=1, and according to whether transform precoder is enabled or disabled, and the values of higher layer parameter codebookSubset;
h) 2 or 4 bits for 2 antenna ports, if txConfig=codebook, ul-FullPowerTransmission-r16 is not configured or configured to fullpowerMode2 or configured to fullpower, and according to whether transform precoder is enabled or disabled, and the values of higher layer parameters maxRank and codebookSubset;
i) 2 bits for 2 antenna ports, if txConfig=codebook, ul-FullPowerTransmission-r16=fullpowerMode1, transform precoder is disabled, maxRank=2, and codebookSubset=nonCoherent;
j) 1 or 3 bits for 2 antenna ports, if txConfig=codebook, ul-FullPowerTransmission-r16 is not configured or configured to fullpowerMode2 or configured to fullpower, and according to whether transform precoder is enabled or disabled, and the values of higher layer parameters maxRank and codebookSubset;
k) 2 bits for 2 antenna ports, if txConfig=codebook, ul-FullPowerTransmission-r16=fullpowerMode1, maxRank=1, and according to whether transform precoder is enabled or disabled, and the values of higher layer parameter codebookSubset;
2) for the higher layer parameter txConfig-codebook, if ul-FullPowerTransmission-r16 is configured to fullpowerMode2, maxRank is configured to be larger than 2, and at least one SRS resource with 4 antenna ports is configured in an SRS resource set with usage set to ‘codebook’ and an SRS resource with 2 antenna ports is indicated via SRI in the same SRS resource set, then a certain table is used; and
3) for the higher layer parameter txConfig=codebook, if different SRS resources with different number of antenna ports are configured, the bitwidth is determined according to the maximum number of ports in an SRS resource among the configured SRS resources in an SRS resource set with usage set to ‘codebook’. If the number of ports for a configured SRS resource in the set is less than the maximum number of ports in an SRS resource among the configured SRS resources, a number of most significant bits with value set to ‘0’ are inserted to the field.

In some embodiments, there may be a DCI Format 0_2 in which:
1) precoding information and number of layers-number of bits determined by the following:
a) 0 bits if the higher layer parameter txConfig=non CodeBook;
b) 0 bits for 1 antenna port and if the higher layer parameter txConfig=codebook;
c) 4, 5, or 6 bits for 4 antenna ports, if txConfig=codebook, ul-FullPowerTransmission-r16 is not configured or configured to fullpowerMode2 or configured to fullpower, and according to whether transform precoder is enabled or disabled, and the values of higher layer parameters maxRank-ForDCIFormat0_2, and codebookSubset-ForDCIFormat0_2;
d) 4 or 5 bits for 4 antenna ports, if txConfig=codebook, ul-FullPowerTransmission-r16=fullpowerMode1, the values of higher layer parameters maxRankForDCI-Format0−2=2, transform precoder is disabled, and according to the value of higher layer parameter codebookSubsetForDCI-Format0-2;
e) 4 or 6 bits for 4 antenna ports, if txConfig=codebook, ul-FullPowerTransmission-r16=fullpowerMode1, the values of higher layer parameters maxRankForDCI-Format0−2=3 or 4, transform precoder is disabled, and according to the value of higher layer parameter codebookSubsetForDCI-Format0-2;
f) 2, 4, or 5 bits for 4 antenna ports, if txConfig=codebook, ul-FullPowerTransmission-r16 is not configured or configured to fullpowerMode2 or configured to fullpower, and according to whether transform precoder is enabled or disabled, and the values of higher layer parameters maxRank-ForDCIFormat0_2, and codebookSubset-ForDCIFormat0_2;
g) 3 or 4 bits for 4 antenna ports, if txConfig=codebook, ul-FullPowerTransmission-r16=fullpowerMode1, maxRankForDCI-Format0−2=1, and according to whether transform precoder is enabled or disabled, and the value of higher layer parameter codebookSubsetForDCI-Format0-2;
h) 2 or 4 bits for 2 antenna ports, if txConfig=codebook, ul-FullPowerTransmission-r16 is not configured or configured to fullpowerMode2 or configured to fullpower, and according to whether transform precoder is enabled or disabled, and the values of higher layer parameters maxRank-ForDCIFormat0_2 and codebookSubset-ForDCIFormat0_2;
i) 2 bits for 2 antenna ports, if txConfig=codebook, ul-FullPowerTransmission-r16=fullpowerMode1, transform precoder is disabled, the maxRankForDCI-Format0-2-2, and codebookSubsetForDCI-Format0-2=nonCoherent;
j) 1 or 3 bits for 2 antenna ports, if txConfig=codebook, ul-FullPowerTransmission-r16 is not configured or configured to fullpowerMode2 or configured to fullpower, and according to whether transform precoder is enabled or disabled, and the values of higher layer parameters maxRank-ForDCIFormat0_2 and codebookSubset-ForDCIFormat0_2;
k) 2 bits for 2 antenna ports, if txConfig=codebook, ul-FullPowerTransmission-r16-fullpowerMode1, maxRankForDCI-Format0−2=1, and according to whether transform precoder is enabled or disabled, and the value of higher layer parameter codebookSubsetForDCI-Format0-2;
2) for the higher layer parameter txConfig=codebook, if ul-FullPowerTransmission-r16 is configured to fullpowerMode2, the values of higher layer parameters maxRankForDCI-Format0-2 is configured to be larger than 2, and at least one SRS resource with 4 antenna ports is configured in an SRS resource set with usage set to ‘codebook’ and an SRS resource with 2 antenna ports is indicated via SRI in the same SRS resource set, then a certain table is used; and
3) for the higher layer parameter txConfig=codebook, if different SRS resources with different number of antenna ports are configured, the bitwidth is determined according to the maximum number of ports in an SRS resource among the configured SRS resources in an SRS resource set with usage set to ‘codebook’. If the number of ports for a configured SRS resource in the set is less than the maximum number of ports in an SRS resource among the configured SRS resources, a number of most significant bits with value set to ‘0’ are inserted to the field.

In various embodiments there may be precoding according to the following:

The block of vectors [y⁽⁰⁾(i) . . . y^{(u-1)}(i)]^{T}, i=0,1, . . . , M_{symb}^{layer}−1 shall be precoded according to:

$$[ \begin{matrix}{z}^{( {p}_{0} )} ( i ) \\ ⋮ \\ {z}^{( {p}_{ρ - 1} )} ( i )\end{matrix} ] = W [ \begin{matrix}{y}^{( 0 )} ( i ) \\ ⋮ \\ {y}^{( υ - 1 )} ( i )\end{matrix} ] ,$$

where i=0,1, . . . , M_{symb}^{ap}−1, M_{symb}^{ap}=M_{symb}^{layer}. The set of antenna ports {p₀, . . . ,p_{ρ-1}} shall be determined.

For non-codebook-based transmission, the precoding matrix W equals the identity matrix.

For codebook-based transmission, the precoding matrix W is given by W=1 for single-layer transmission on a single antenna port, otherwise by tables with the TPMI index obtained from the DCI scheduling the uplink transmission or the higher layer parameters.

When the higher-layer parameter txConfig is not configured, the precoding matrix W=1. Tables 16 through 22 may be used with embodiments described herein.

TABLE 14
Precoding matrix W for single-layer transmission using two antenna ports

| TPMI | W | | | | | | | |
|---|---|---|---|---|---|---|---|---|
| index | (ordered from left to right in increasing order of TPMI index) | | | | | | | |
| 0-5 | $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ | — | — |

TABLE 15
Precoding matrix W for
single-layer transmission using four antenna ports with transform precoding enabled

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}\begin{matrix}\begin{matrix}1 \\ 0\end{matrix} \\ 0\end{matrix} \\ 0\end{matrix} ]$ | $\frac{1}{2} [ \begin{matrix}\begin{matrix}\begin{matrix}0 \\ 1\end{matrix} \\ 0\end{matrix} \\ 0\end{matrix} ]$ | $\frac{1}{2} [ \begin{matrix}\begin{matrix}\begin{matrix}0 \\ 0\end{matrix} \\ 1\end{matrix} \\ 0\end{matrix} ]$ | $\frac{1}{2} [ \begin{matrix}\begin{matrix}\begin{matrix}0 \\ 0\end{matrix} \\ 0\end{matrix} \\ 1\end{matrix} ]$ | $\frac{1}{2} [ \begin{matrix}\begin{matrix}\begin{matrix}1 \\ 0\end{matrix} \\ 1\end{matrix} \\ 0\end{matrix} ]$ | $\frac{1}{2} [ \begin{matrix}\begin{matrix}\begin{matrix}1 \\ 0\end{matrix} \\ - 1\end{matrix} \\ 0\end{matrix} ]$ | $\frac{1}{2} [ \begin{matrix}\begin{matrix}\begin{matrix}1 \\ 0\end{matrix} \\ j\end{matrix} \\ 0\end{matrix} ]$ | $\frac{1}{2} [ \begin{matrix}\begin{matrix}\begin{matrix}1 \\ 0\end{matrix} \\ - j\end{matrix} \\ 0\end{matrix} ]$ |
| 8-15 | $\frac{1}{2} [ \begin{matrix}\begin{matrix}\begin{matrix}0 \\ 1\end{matrix} \\ 0\end{matrix} \\ 1\end{matrix} ]$ | $\frac{1}{2} [ \begin{matrix}\begin{matrix}\begin{matrix}0 \\ 1\end{matrix} \\ 0\end{matrix} \\ - 1\end{matrix} ]$ | $\frac{1}{2} [ \begin{matrix}\begin{matrix}\begin{matrix}0 \\ 1\end{matrix} \\ 0\end{matrix} \\ j\end{matrix} ]$ | $\frac{1}{2} [ \begin{matrix}\begin{matrix}\begin{matrix}0 \\ 1\end{matrix} \\ 0\end{matrix} \\ - j\end{matrix} ]$ | $\frac{1}{2} [ \begin{matrix}\begin{matrix}\begin{matrix}1 \\ 1\end{matrix} \\ 1\end{matrix} \\ - 1\end{matrix} ]$ | $\frac{1}{2} [ \begin{matrix}\begin{matrix}\begin{matrix}1 \\ 1\end{matrix} \\ j\end{matrix} \\ j\end{matrix} ]$ | $\frac{1}{2} [ \begin{matrix}\begin{matrix}\begin{matrix}1 \\ 1\end{matrix} \\ - 1\end{matrix} \\ 1\end{matrix} ]$ | $\frac{1}{2} [ \begin{matrix}\begin{matrix}\begin{matrix}1 \\ 1\end{matrix} \\ - j\end{matrix} \\ - j\end{matrix} ]$ |
| 16-23 | $\frac{1}{2} [ \begin{matrix}\begin{matrix}\begin{matrix}1 \\ j\end{matrix} \\ 1\end{matrix} \\ j\end{matrix} ]$ | $\frac{1}{2} [ \begin{matrix}\begin{matrix}\begin{matrix}1 \\ j\end{matrix} \\ j\end{matrix} \\ 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ - 1\end{matrix} ]$ | $\frac{1}{2} [ \begin{matrix}1 \\ - 1 \\ 1 \\ 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ - 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ - 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ 1\end{matrix} ]$ | — | — | — | — |

TABLE 16
Precoding matrix W for
single-layer transmission using four antenna ports with transform precoding disabled

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

TABLE 17
Precoding matrix W for two-layer transmission using
two antenna ports with transform precoding disabled

| TPMI | W | | |
|---|---|---|---|
| index | (ordered from left to right in increasing order of TPMI index) | | |
| 0-2 | $\frac{1}{\sqrt{2}} [ \begin{matrix}1 & 0 \\ 0 & 1\end{matrix} ]$ | $\frac{1}{2} [ \begin{matrix}1 & 1 \\ 1 & - 1\end{matrix} ]$ | $\frac{1}{2} [ \begin{matrix}1 & 1 \\ j & - j\end{matrix} ]$ |

TABLE 18
Precoding matrix W for
two-layer transmission using four antenna ports with transform precoding disabled

| TPMI | W | | | |
|---|---|---|---|---|
| index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ 1 & - j \\ 1 & - 1\end{matrix} ]$ | — | — |

TABLE 19
Precoding matrix W for
three-layer transmission using four antenna ports with transform precoding disabled

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

TABLE 20
Precoding matrix W for four-layer transmission using four antenna ports with transform precoding disabled

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

In certain embodiments there may be non-codebook-based UL transmission. For non-codebook based transmission, PUSCH can be scheduled by DCI format 0_0, DCI format 0_1, DCI format 0_2 or semi-statically configured to operate. If this PUSCH is scheduled by DCI format 0_1, DCI format 0_2, or semi-statically configured to operate, the UE can determine its PUSCH precoder and transmission rank based on the SRI when multiple SRS resources are configured, where the SRI is given by the SRS resource indicator in DCI for DCI format 0_1 and DCI format 0_2, or the SRI is given by srs-ResourceIndicator. The SRS-ResourceSet(s) applicable for PUSCH scheduled by DCI format 0_1 and DCI format 0_2 are defined by the entries of the higher layer parameter srs-ResourceSetToAddModList and srs-ResourceSetToAddModListForDCI-Format0-2-r16 in SRS-config, respectively. The UE shall use one or multiple SRS resources for SRS transmission, where, in a SRS resource set, the maximum number of SRS resources which can be configured to the UE for simultaneous transmission in the same symbol and the maximum number of SRS resources are UE capabilities. The SRS resources transmitted simultaneously occupy the same RBs. Only one SRS port for each SRS resource is configured. Only one SRS resource set can be configured with higher layer parameter usage in SRS-ResourceSet set to ‘nonCodebook’. The maximum number of SRS resources that can be configured for non-codebook based uplink transmission is 4. The indicated SRI in slot n is associated with the most recent transmission of SRS resource(s) identified by the SRI, where the SRS transmission is prior to the PDCCH carrying the SRI.

For non-codebook based transmission, the UE can calculate the precoder used for the transmission of SRS based on measurement of an associated non-zero power (“NZP”) CSI-RS resource. A UE can be configured with only one NZP CSI-RS resource for the SRS resource set with higher layer parameter usage in SRS-ResourceSet set to ‘nonCodebook’ if configured.

The UE shall perform one-to-one mapping from the indicated SRI(s) to the indicated DM-RS ports(s) and their corresponding PUSCH layers {0 . . . v-1} given by DCI format 0_1 or by configuredGrantConfig in increasing order.

The UE shall transmit PUSCH using the same antenna ports as the SRS port(s) in the SRS resource(s) indicated by SRI(s) given by DCI format 0_1 or by configuredGrantConfig, where the SRS port in (i+1)-th SRS resource in the SRS resource set is indexed as pᵢ=1000+i.

The DM-RS antenna ports {\tilde{p}₀, . . . ,\tilde{p}ᵤ₋₁} are determined according to the ordering of DM-RS port(s) given by various tables.

For non-codebook based transmission, the UE does not expect to be configured with both spatialRelationInfo for SRS resource and associatedCSI-RS in SRS-ResourceSet for SRS resource set. For non-codebook based transmission, the UE can be scheduled with DCI format 0_1 when at least one SRS resource is configured in SRS-ResourceSet with usage set to ‘nonCodebook’.

In certain embodiments, there may be a UE sounding procedure.

Moreover, there may be an SRS configuration. The UE may be configured with one or more SRS resource sets as configured by the higher layer parameter SRS-ResourceSet, wherein each SRS resource set is associated with K≥1 SRS resources (e.g., higher layer parameter SRS-Resource), where the maximum value of K is indicated by UE capability. The SRS resource set applicability is configured by the higher layer parameter usage in SRS-ResourceSet. The higher-layer parameter SRS-Resource configures some SRS parameters, including the SRS resource configuration identity (e.g., srs-ResourceId), the number of SRS ports (e.g., nrofSRS-Ports) with default value of one, and the time-domain behavior of SRS resource configuration (e.g., resource Type).

The UE may be configured by the higher layer parameter resourceMapping in SRS-Resource with an SRS resource occupying N_{S}∈{1,2,4} adjacent symbols within the last 6 symbols of the slot, where all antenna ports of the SRS resources are mapped to each symbol of the resource.

For a UE configured with one or more SRS resource configuration(s), and when the higher layer parameter resource Type in SRS-Resource is set to ‘aperiodic’:
1) the UE receives a configuration of SRS resource sets;
2) the UE receives a downlink DCI, a group common DCI, or an uplink DCI based command where a codepoint of the DCI may trigger one or more SRS resource set(s). For SRS in a resource set with usage set to ‘codebook’ or ‘antennaSwitching’, the minimal time interval between the last symbol of the PDCCH triggering the aperiodic SRS transmission and the first symbol of SRS resource is N2. Otherwise, the minimal time interval between the last symbol of the PDCCH triggering the aperiodic SRS transmission and the first symbol of SRS resource is N2+14. The minimal time interval in units of OFDM symbols is counted based on the minimum subcarrier spacing between the PDCCH and the aperiodic SRS;
3) if the UE is configured with the higher layer parameter spatial RelationInfo containing the ID of a reference ‘ssb-Index’, the UE shall transmit the target SRS resource with the same spatial domain transmission filter used for the reception of the reference SS/PBCH block, if the higher layer parameter spatialRelationInfo contains the ID of a reference ‘csi-RS-Index’, the UE shall transmit the target SRS resource with the same spatial domain transmission filter used for the reception of the reference periodic CSI-RS or of the reference semi-persistent CSI-RS, or of the latest reference aperiodic CSI-RS. If the higher layer parameter spatialRelationInfo contains the ID of a reference ‘srs’, the UE shall transmit the target SRS resource with the same spatial domain transmission filter used for the transmission of the reference periodic SRS or of the reference semi-persistent SRS or of the reference aperiodic SRS;
4) the update command contains spatial relation assumptions provided by a list of references to reference signal IDs, one per element of the updated SRS resource set. Each ID in the list refers to a reference SS/PBCH block, NZP CSI-RS resource configured on serving cell indicated by Resource Serving Cell ID field in the update command if present, same serving cell as the SRS resource set otherwise, or SRS resource configured on serving cell and uplink bandwidth part indicated by Resource Serving Cell ID field and Resource BWP ID field in the update command if present, same serving cell and bandwidth part as the SRS resource set otherwise; and
5) when the UE is configured with the higher layer parameter usage in SRS-ResourceSet set to ‘antennaSwitching’, the UE shall not expect to be configured with different spatial relations for SRS resources in the same SRS resource set.

For physical uplink control channel (“PUCCH”) and SRS on the same carrier, a UE shall not transmit SRS when semi-persistent and periodic SRS are configured in the same symbol(s) with PUCCH carrying only CSI report(s), or only L1-RSRP report(s), or only L1-SINR report(s). A UE shall not transmit SRS when semi-persistent or periodic SRS is configured or aperiodic SRS is triggered to be transmitted in the same symbol(s) with PUCCH carrying hybrid automatic repeat request (“HARQ”) acknowledgement (“ACK”) (“HARQ-ACK”), link recovery request and/or SR. In the case that SRS is not transmitted due to overlap with PUCCH, only the SRS symbol(s) that overlap with PUCCH symbol(s) are dropped. PUCCH shall not be transmitted when aperiodic SRS is triggered to be transmitted to overlap in the same symbol with PUCCH carrying semi-persistent/periodic CSI report(s) or semi-persistent/periodic L1-RSRP report(s) only, or only L1-SINR report(s).

When the UE is configured with the higher layer parameter usage in SRS-ResourceSet set to ‘antennaSwitching’, and a guard period of Y symbols is configured, the UE shall use the same priority rules as defined above during the guard period as if SRS was configured.

In some embodiments, there may be a UE sounding procedure. When the UE is configured with the higher-layer parameter usage in SRS-ResourceSet set as ‘antennaSwitching’, the UE may be configured with one configuration depending on the indicated UE capability supportedSRS-TxPortSwitch, which takes on the values {‘t1r2’, ‘t1r1−t1r2’, ‘t2r4’, ‘t1r4’, ‘t1r1−t1r2−t1r4’, ‘t1r4−t2r4’, ‘t1r1−t1r2−t2r2−t2r4’, ‘t1r1−t1r2−t2r2−t1r4−t2r4’, ‘t1r1’, ‘t2r2’, ‘t1r1−t2r2’, ‘t4r4’, ‘t1r1−t2r2−t4r4’}:
1) for 1T2R, up to two SRS resource sets configured with a different value for the higher layer parameter resourceType in SRS-ResourceSet set, where each set has two SRS resources transmitted in different symbols, each SRS resource in a given set consisting of a single SRS port, and the SRS port of the second resource in the set is associated with a different UE antenna port than the SRS port of the first resource in the same set;
2) for 2T4R, up to two SRS resource sets configured with a different value for the higher layer parameter resourceType in SRS-ResourceSet set, where each SRS resource set has two SRS resources transmitted in different symbols, each SRS resource in a given set consisting of two SRS ports, and the SRS port pair of the second resource is associated with a different UE antenna port pair than the SRS port pair of the first resource;
3) for 1T4R, zero or one SRS resource set configured with higher layer parameter resourceType in SRS-ResourceSet set to ‘periodic’ or ‘semi-persistent’ with four SRS resources transmitted in different symbols, each SRS resource in a given set consisting of a single SRS port, and the SRS port of each resource is associated with a different UE antenna port;
4) for 1T4R, zero or two SRS resource sets each configured with higher layer parameter resourceType in SRS-ResourceSet set to ‘aperiodic’ and with a total of four SRS resources transmitted in different symbols of two different slots, and where the SRS port of each SRS resource in the given two sets is associated with a different UE antenna port. The two sets are each configured with two SRS resources, or one set is configured with one SRS resource and the other set is configured with three SRS resources; and/or
5) For 1T=1R, or 2T=2R, or 4T=4R, up to two SRS resource sets each with one SRS resource, where the number of SRS ports for each resource is equal to 1, 2, or 4.

The UE is configured with a guard period of Y symbols, in which the UE does not transmit any other signal, in the case the SRS resources of a set are transmitted in the same slot. The guard period is in-between the SRS resources of the set. The value of Y is 2 when the OFDM sub-carrier spacing is 120 kHz, otherwise Y=1.

For 1T2R, 1T4R or 2T4R, the UE shall not expect to be configured or triggered with more than one SRS resource set with higher layer parameter usage set as ‘antennaSwitching’ in the same slot. For 1T=1R, 2T=2R or 4T=4R, the UE shall not expect to be configured or triggered with more than one SRS resource set with higher layer parameter usage set as ‘antennaSwitching’ in the same symbol.

In certain embodiments, PUSCH transmissions may be dynamically scheduled by an UL grant in a DCI, or the transmission can correspond to a configured grant Type 1 or Type 2. The configured grant Type 1 PUSCH transmission is semi-statically configured to operate upon the reception of higher layer parameter of configuredGrantConfig including rrc-ConfiguredUplinkGrant without the detection of an UL grant in a DCI. The configured grant Type 2 PUSCH transmission is semi-persistently scheduled by an UL grant in a valid activation DCI after the reception of higher layer parameter configuredGrantConfig not including rrc-ConfiguredUplinkGrant. If configuredGrantConfigToAddModList-r16 is configured, more than one configured grant configuration of configured grant Type 1 and/or configured grant Type 2 may be active at the same time on an active BWP of a serving cell.

In some embodiments, for the PUSCH transmission corresponding to a Type 1 configured grant or a Type 2 configured grant activated by DCI format 0_0 or 0_1, the parameters applied for the transmission are provided by configuredGrantConfig except for dataScramblingIdentityPUSCH, txConfig, codebookSubset, maxRank, scaling of UCI-OnPUSCH, which are provided by pusch-Config. For the PUSCH transmission corresponding to a Type 2 configured grant activated by DCI format 0_2, the parameters applied for the transmission are provided by configuredGrantConfig except for dataScramblingIdentityPUSCH, txConfig, codebookSubsetForDCI-Format0-2-r16, maxRankForDCI-Format0-2-r16, scaling of UCI-OnPUSCH, resourceAllocationType1GranularityForDCI-Format0-2-r16 provided by pusch-Config. If the UE is provided with transformPrecoder in configuredGrantConfig, the UE applies the higher layer parameter tp-pi2BPSK, if provided in pusch-Config, according to the procedure described in Clause 6.1.4 of [1] for the PUSCH transmission corresponding to a configured grant.

In various embodiments, for the PUSCH retransmission scheduled by a PDCCH with a cyclic redundancy check (“CRC”) scrambled by configured scheduling (“CS”) RNTI (“CS-RNTI”) with new data indicator (“NDI”)=1, the parameters in pusch-Config are applied for the PUSCH transmission except for p0-NominalWithoutGrant, p0-PUSCH-Alpha, powerControlLoopToUse, pathlossReferenceIndex, mcs-Table, mcs-Table TransformPrecoder, and transformPrecoder. For a UE configured with two uplinks in a serving cell, PUSCH retransmission for a transport block (“TB”) on the serving cell is not expected to be on a different uplink than the uplink used for the PUSCH initial transmission of that TB.

In certain embodiments, a UE shall upon detection of a PDCCH with a configured DCI format 0_0, 0_1 or 0_2 transmit the corresponding PUSCH as indicated by that DCI. Upon detection of a DCI format 0_1 or 0_2 with “UL-SCH indicator” set to “0” and with a non-zero “CSI request” where the associated “reportQuantity” in CSI-ReportConfig set to “none” for all CSI report(s) triggered by “CSI request” in this DCI format 0_1 or 0_2, the UE ignores all fields in this DCI except the “CSI request” and the UE shall not transmit the corresponding PUSCH as indicated by this DCI format 0_1 or 0_2. When the UE is scheduled with multiple PUSCHs by a DCI, HARQ process ID indicated by this DCI applies to the first PUSCHHARQ process ID is then incremented by 1 for each subsequent PUSCH(s) in the scheduled order, with modulo 16 operation applied. For any HARQ process ID(s) in a given scheduled cell, the UE is not expected to transmit a PUSCH that overlaps in time with another PUSCH. For any two HARQ process IDs in a given scheduled cell, if the UE is scheduled to start a first PUSCH transmission starting in symbol j by a PDCCH ending in symbol i, the UE is not expected to be scheduled to transmit a PUSCH starting earlier than the end of the first PUSCH by a PDCCH that ends later than symbol i. The UE is not expected to be scheduled to transmit another PUSCH by DCI format 0_0, 0_1 or 0_2 scrambled by cell (“C”) radio network temporary identifier (“RNTI”) (“C-RNTI”) or modulation and coding scheme (“MSC”) (“MCS-C-RNTI”) for a given HARQ process until after the end of the expected transmission of the last PUSCH for that HARQ process.

In a first set of embodiments, there may be an indication of an UL codebook. In general, the network may configure a UE with a UL codebook via a combination of one or more indications represented in the first set of embodiments. It should be noted that there may be a combination of one or more embodiments found herein.

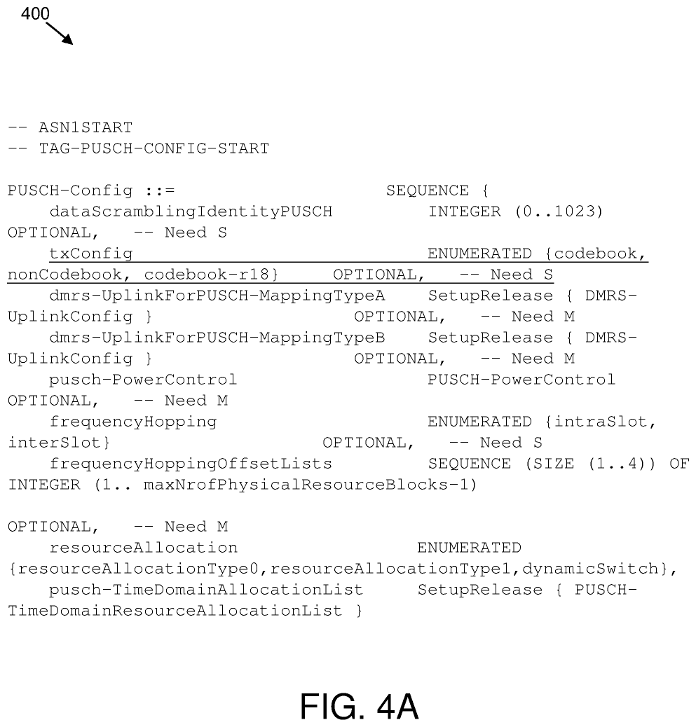

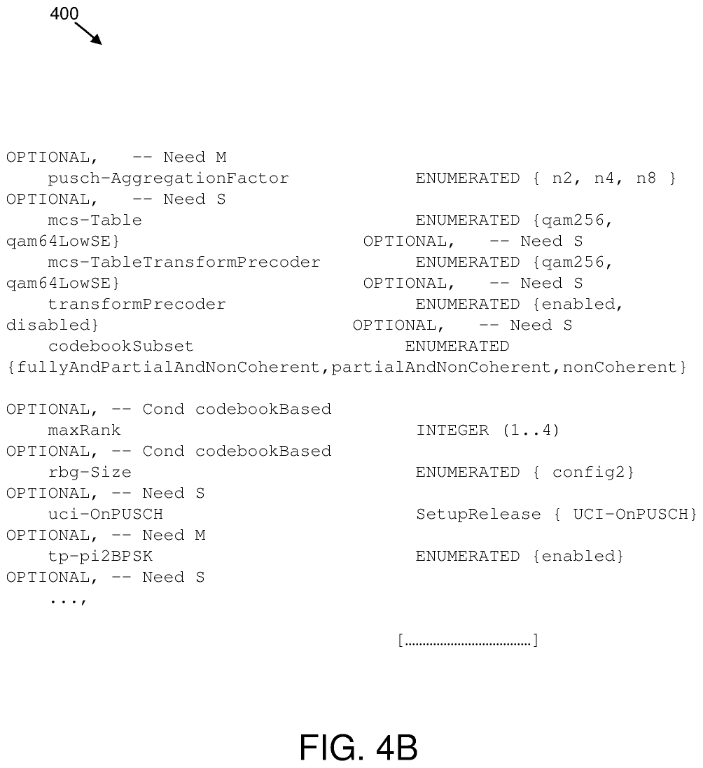

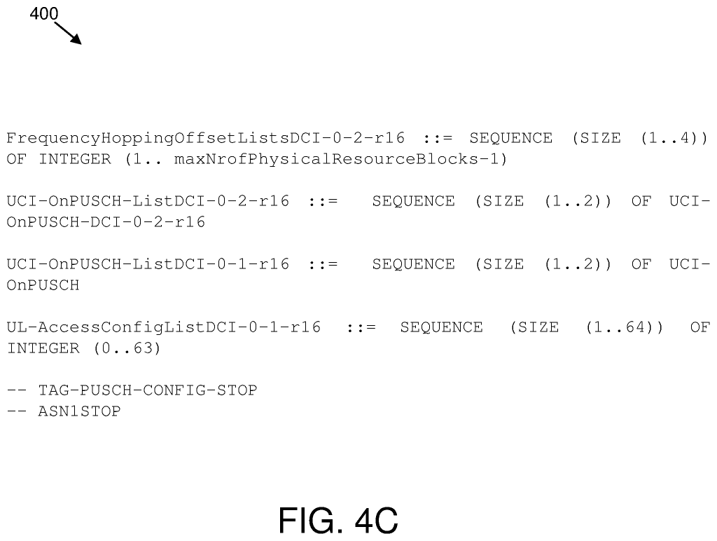

In a first embodiment of the first set of embodiments, a new value of the higher-layer parameter txConfig in PUSCH-Config informational element (“IE”) is used. In a first example, the new value is ‘codebook-r18’. An example of the abstract syntax notation 1 (“ASN.1”) code for the first embodiment of the first set of embodiments for the PUSCH Configuration IE is shown in FIGS. 4A through 4C. Specifically, FIGS. 4A through 4C are block diagrams illustrating one embodiment of ASN.1 code 400 in a PUSCH-Config IE.

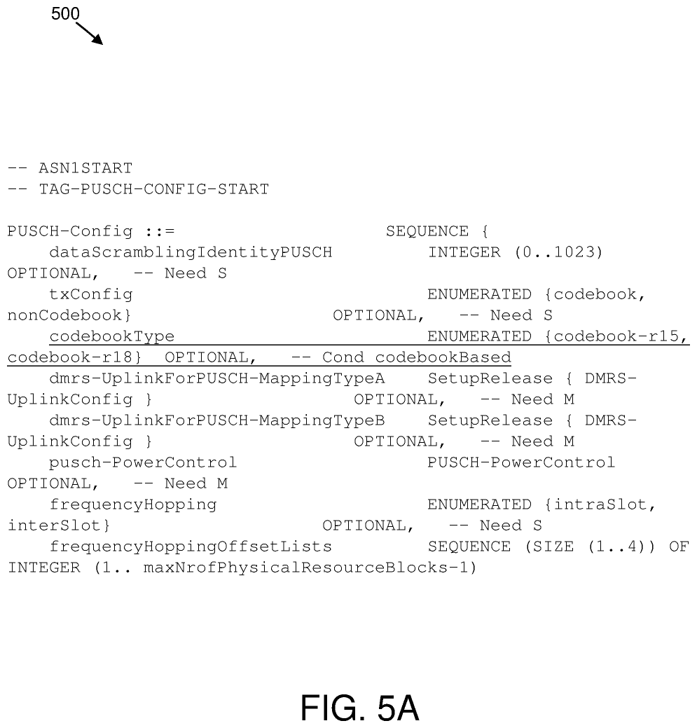

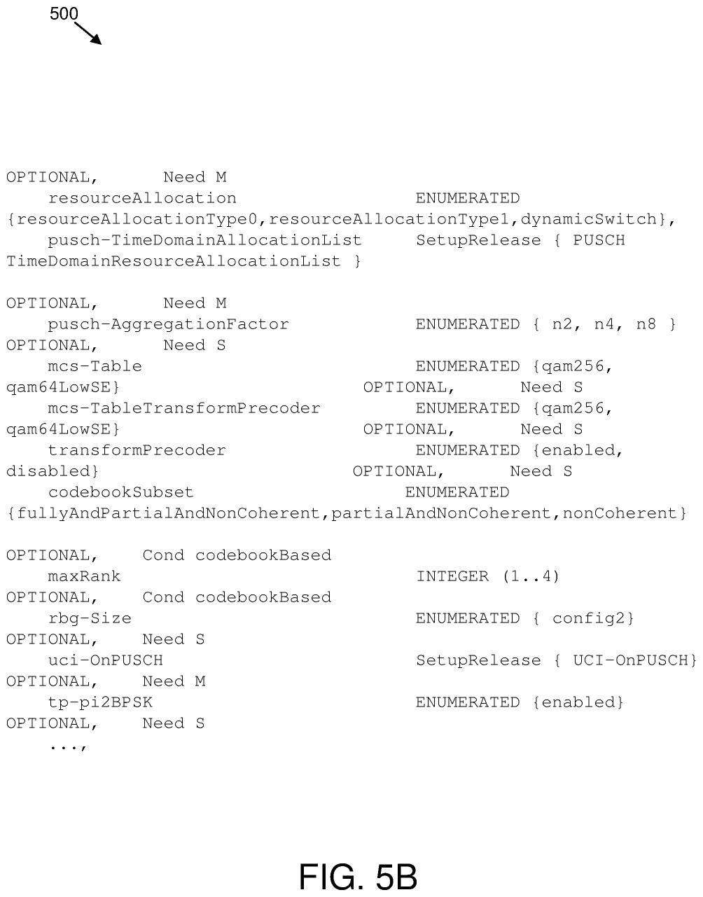

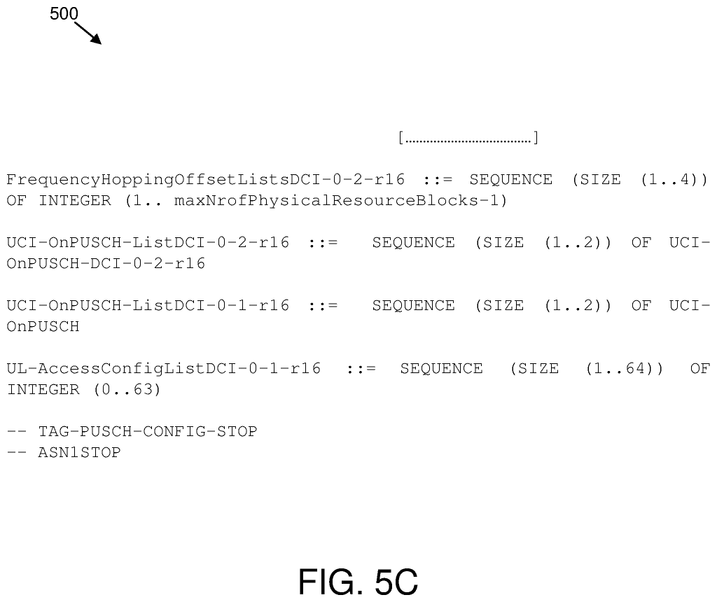

In a second embodiment of the first set of embodiments, a new higher-layer parameter, e.g., ‘CodebookType’ that indicates the codebook type, is used in PUSCH-Config IE. In a first example, the new higher-layer parameter may take on one or more values, e.g., ‘codebook-r18’, ‘codebook-r15’. In a second example, the new higher-layer parameter is configured if the higher-layer parameter txConfig in PUSCH-Config IE is configured with the value ‘codebook’. An example of the ASN.1 code that corresponds to the second embodiment of the first set of embodiments for the PUSCH Configuration IE is shown in FIGS. 5A through 5C. Specifically, FIGS. 5A through 5C are block diagrams illustrating another embodiment of ASN.1 code 500 in a PUSCH-Config IE.

In a third embodiment of the first set of embodiments, an UL codebook is inferred from the value of a “Precoding information and number of layers” field (e.g., one or more codepoints of the field) in a DCI scheduling PUSCH transmission, e.g., DCI Format 0_1 or DCI Format 0_2. This value indicates that an UL codebook is used for the PUSCH transmission and a TPMI is reported, signaled, indicated, and/or provided in a following DCI that is transmitted, e.g., over PDCCH, PDSCH, or indicated in a medium access control (“MAC”) control element (“CE”) (“MAC-CE”, “MAC CE”) on PDSCH. In one example, the value of a “Precoding information and number of layers” field in the DCI scheduling PUSCH transmission indicates that the TPMI follows the most recent indicated TPMI(s) (e.g., sub-band TPMIs) to the UE. The most recent indicated TPMI may be indicated in a DCI that is transmitted, e.g., over PDCCH, PDSCH, or indicated in a MAC-CE on PDSCH.

In a fourth embodiment of the first set of embodiments, an UL codebook is inferred from the value of a higher-layer parameter usage for an SRS-resourceSet. In one example, the parameter usage set to ‘codebook-r18’.

In a second set of embodiments, there may be a structure of an UL codebook.

In a first embodiment of the second set of embodiments, an UL codebook includes L spatial beams, wherein L21, and L≤Nₜₓ, wherein Nₜₓ represents a number of SRS ports (or antenna ports) at the UE. In one example, a Fourier-based transform, e.g., discrete Fourier transform, is used to map the Nₜₓ ports to the L spatial beams, similar to a structure of a transformation matrix W₁.

In a second embodiment of the second set of embodiments, an UL codebook includes M FD basis indices, wherein M>1, and M<N_{sb}, wherein N_{sb} represents a number of configured sub-bands for UL transmission in a BWP. In one example, the frequency-domain basis transformation is a Discrete Fourier transformation, as follows:

$${y}_{t , l} = [ \begin{matrix}{y}_{t , l}^{( 0 )} & {y}_{t , l}^{( 1 )} & … & {y}_{t , l}^{( {M}_{υ} - 1 )}\end{matrix} ] ,$$

where t={0,1, . . . ,N₃−1} represents the index of the PMI sub-band out of N₃ PMI sub-bands, and l is the layer index associated with the precoding matrix, l={1, . . . ,v}, such that:

$${y}_{t , l}^{( f )} = {e}^{j \frac{2 π {tn}_{3 , l}^{( f )}}{{N}_{3}}} ,$$

for f=0,1, . . . ,Mᵤ−1, where f is the index of the (transformed) frequency domain basis, and Mᵥ represents the size of the frequency domain basis for a given rank v.

In a third embodiment of the second set of embodiments, a sub-band is configured for UL. One example of a table of configurable sub-band sizes is illustrated as Table 23.

TABLE 21
Sub-band configuration per BWP for UL transmission

| Bandwidth part (PRBs) | Sub-band size (PRBs) |
|---|---|
| 24-72 | 8 |
| 73-144 | 16 |
| 145-275 | 32 |

In a fourth embodiment of the second set of embodiments, no sub-band size is configured if the higher-layer parameter precoder transform is configured. In a first example, M=1. In a second example, a PMI format indicator is set to ‘wideband’.

In a fifth embodiment of the second set of embodiments, a number of coefficient values for each layer are reported, signaled, indicated, and/or provided for the codebook, wherein amplitude values, phase values, or a combination thereof, are reported, signaled, indicated, and/or provided, and wherein the number of coefficient values depends on one or more of the number of spatial beams and the number of FD basis indices. In one example, a coefficient corresponding to the i^{th} beam, wherein i∈{0,1, . . . ,L−1}, and the m^{th} FD basis index, wherein m∈{0,1, . . . , M−1}, for layer l, wherein l∈{1, . . . ,v}, and v is the transmission rank, is represented by c_{l,i,m}, and wherein c_{l,i,m} is quantized in the form of a product of one or more amplitude values, e.g., two amplitude, values a_{l,i,m}⁽¹⁾ and a_{l,i,m}⁽²⁾, wherein |c_{l,i,m}|=a_{l,i,m}⁽¹⁾·a_{l,i,m}⁽²⁾, and one phase value, e.g., p_{l,i,m} where angle(c_{l,i,m})=p_{l,i,m}.

In a sixth embodiment of the second set of embodiments, a bitmap is reported, signaled, indicated, and/or provided that indicates whether a coefficient value is reported, signaled, indicated, and/or provided. In a first example, a bit corresponding to each coefficient c_{l,i,m}, e.g., b_{l,i,m} is reported, wherein b_{l,i,m}=0 for an unreported coefficient, and b_{l,i,m}=1 for a reported coefficient. In a second example, an unreported coefficient takes on a zero amplitude value.

In a seventh embodiment of the second set of embodiments, a network reports an SRI that corresponds to up to two SRS resources.

In an eighth embodiment of the second set of embodiments, a rank indicator (“RI”) is reported, signaled, indicated, and/or provided in the CSI feedback report, signaling, and/or indication.

In a ninth embodiment of the second set of embodiments, an indicator corresponding to one or more of a strongest coefficient per layer and a stronger polarization of two polarizations is reported, signaled, indicated, and/or provided, wherein a polarization corresponds to one of two replicas of the set of spatial beams.

In a tenth embodiment of the second set of embodiments, a parameter corresponding to the total number of non-zero coefficients is reported, signaled, indicated, and/or provided in the CSI feedback report, signaling, and/or indication.

In a third set of embodiments, there may be codebook reporting.

In a first embodiment of the third set of embodiments, a subset of the codebook parameters is reported, signaled, indicated, and/or provided in the form of one or more codepoints of the “Precoding information and number of layers” field in a DCI that scheduling PUSCH transmission, e.g., DCI Format 0_1, DCI Format 0_2. In a first example, a rank indicator is reported, signaled, indicated, and/or provided within the “Precoding information and number of layers” field. In a second example, an SRS resource indicator (“SRI”) is reported, signaled, indicated, and/or provided within the “Precoding information and number of layers” field.

In a second embodiment of the third set of embodiments, a subset of the codebook parameters is reported, signaled, indicated, and/or provided in the form of one or more higher-layer parameters within the PUSCH Config IE. In a first example, the txConfig parameter represents an IE that comprises two or more higher-layer parameters. In a second example, a new IE, e.g., codebook-r18 IE, is used within the PUSCH Config IE. In a third example, the subset of the codebook parameters includes one or more of: the number of spatial beams, the number of FD basis indices, the SRI, the RI, the configured sub-band size, the strongest coefficient indicator, and the bitmap.

In a third embodiment of the third set of embodiments, a subset of the codebook parameters is reported, signaled, indicated, and/or provided in a second-stage DCI that is carried on a PDSCH, a PDCCH, a MAC-CE on PDSCH, or a combination thereof. In a first example, a second stage DCI transmitted on PDCCH that is piggy-backed or linked to the PDCCH with DCI of Format 0_2 carries, provides, and/or indicates the codebook parameters. In a second example, a DCI transmitted on PDSCH or a MAC-CE on PDSCH carries the codebook parameters. In a third example, a combination of a second-stage DCI on PDCCH and a DCI on PDSCH are transmitted to carry the codebook parameters. In a fourth example, the second-stage DCI comprises the subset of the codebook parameters, including the SRI, the RI, the number of spatial beams, the indices of the selected spatial beams, the number of FD basis indices, the indices of the selected FD basis indices, the strongest coefficient indicator per layer, the number of non-zero coefficients, the bitmap corresponding to the indices of the non-zero coefficients per layer, the coefficient values including one or more of the amplitude and phase values.

In a fourth embodiment of the third set of embodiments, a new DCI format, e.g., DCI Format 0_3 is used, wherein the new DCI format includes parameters that correspond to the UL CSI (or TPMI) of the UE with one or more network nodes. In a first example, the transmission of the new DCI format is conditioned on the UE being configured with an UL codebook.

In a fifth embodiment of the third set of embodiments, the “Precoding information and number of layers” field in a DCI is ‘reserved’ whenever a UE is configured with an UL codebook.

In a sixth embodiment of the third set of embodiments, the number of bits allocated to the “Precoding information and number of layers” field in a DCI is zero whenever a UE is configured with an UL codebook.

In a fourth set of embodiments, there may be CSI feedback for a multi-panel UE.

In a first embodiment of the fourth set of embodiments, a UE that is configured with a TCI codepoint corresponds to two TCI states is also configured to receive up to two TPMI, wherein the two TCI states include quasi co-location (“QCL”) information related to spatial relation corresponding to different downlink reference signals, and the different downlink reference signals are associated with one or more SRS resource sets.

In a second embodiment of the fourth set of embodiments, a UE that is configured with two SRS resource sets that are configured with the higher layer parameter related to usage set to an enhanced codebook, e.g., ‘codebook-r18’, and is also configured to receive up to two TPMI.

In a third embodiment of the fourth set of embodiments, a UE that is configured with enhanced codebook that receives an SRI corresponding to multiple SRS resources is also configured to receive multiple TPMI. In a first example, a UE that receives an SRI corresponding to N SRS resources is also configured to receive N TPMI, wherein N>1.

In a fourth embodiment of the fourth set of embodiments, a UE that is configured with enhanced UL codebook and is also configured to receive an SRS resource set configuration with a spatial relation info that includes an NZP CSI-RS resource ID is configured to receive N TPMI, wherein N>1, and the codepoint for the NZP CSI-RS resource corresponds to two NZP CSI-RS resources.

In a fifth set of embodiments, there may be an exploiting of UL-DL channel reciprocity for an UL codebook. Due to the exploitation of the frequency-division duplexing (“FDD”) reciprocity of the channel, a gNB may transmit beamformed CSI-RSs, where the CSI-RS beamforming is based on the UL channel estimated via SRS transmission. The beamforming can then flatten the channel in the frequency domain, i.e., a fewer number of significant channel taps, i.e., taps with relatively large power, are observed at the UE compared with non-beamformed CSI-RS transmission. Such beamforming may result in a fewer number of coefficients corresponding to fewer FD basis indices being fed back in a CSI report. There may be a novel framework, wherein a UE can exploit DL CSI information corresponding to a DL codebook to construct an UL codebook with a fewer number of feedback bits compared with a scenario with no exploitation of the channel reciprocity. Several embodiments are described herein and one or more of the described embodiments may be combined.

In a first embodiment of the fifth set of embodiments, a subset of the UL codebook parameters, e.g., L, M, RI, i.e., the number of spatial beams, the number of FD basis indices, and the rank indicator, or a subset of the UL codebook parameters, e.g., the index(es) of spatial beams (if specified), or the index(es) of the FD basis (if specified), or the amplitude coefficient values of a subset of the set of codebook coefficients, or first stage amplitude values of two-stage amplitude values of a subset (or all) of the codebook coefficients can be inferred from a prior DL codebook information, wherein the NZP CSI-RS resource ID corresponding to the DL codebook is included in the spatial relation info corresponding to the SRS configuration used for UL channel measurement.

In a second embodiment of the fifth set of embodiments, a subset of the codebook information, e.g., indices of the selected spatial beam indices, indices of the selected FD basis indices, or both, may be exploited from DL codebook information, i.e., not reported, signaled, indicated, and/or provided as part of CSI feedback for UL transmission.

In a third embodiment of the fifth set of embodiments, a subset of the UL codebook parameters, e.g., L, M, RI, i.e., the number of spatial beams, the number of FD basis indices, and the rank indicator, or a subset of the UL codebook parameters, e.g., the index(es) of spatial beams (if specified), or the index(es) of the FD basis (if specified), or the amplitude coefficient values of a subset of the set of codebook coefficients, or first stage amplitude values of two-stage amplitude values of a subset (or all) of the codebook coefficients can be inferred from a prior DL codebook information, wherein the NZP CSI-RS resource ID corresponding to the DL codebook is included in the spatial relation info corresponding to the SRS configuration used for UL channel measurement, and wherein that NZP CSI-RS resource is configured in a CSI reporting configuration CSI-ReportConfig that either configures a reporting quantity ReportQuantity that includes a PMI quantity, or configures an NR codebook, e.g., Type-II Port Selection codebook ‘typeII-PortSelection-r16’, and wherein the CSI reporting configuration is configured within a time threshold, e.g., X slots where X=40 slots, from either the PUSCH Configuration PUSCH-Config time, the transmission/reception of a DCI scheduling PUSCH transmission, e.g., DCI Format 0_2, or a combination thereof.

In some embodiments, the terms antenna, panel, and antenna panel are used interchangeably. An antenna panel may be hardware that is used for transmitting and/or receiving radio signals at frequencies lower than 6 GHz (e.g., frequency range 1 (“FR1”)), or higher than 6 GHz (e.g., frequency range 2 (“FR2”) or millimeter wave (“mmWave”)). In certain embodiments, an antenna panel may include an array of antenna elements. Each antenna element may be connected to hardware, such as a phase shifter, that enables a control module to apply spatial parameters for transmission and/or reception of signals. The resulting radiation pattern may be called a beam, which may or may not be unimodal and may allow the device to amplify signals that are transmitted or received from spatial directions.

In various embodiments, an antenna panel may or may not be virtualized as an antenna port. An antenna panel may be connected to a baseband processing module through a radio frequency (“RF”) chain for each transmission (e.g., egress) and reception (e.g., ingress) direction. A capability of a device in terms of a number of antenna panels, their duplexing capabilities, their beamforming capabilities, and so forth, may or may not be transparent to other devices. In some embodiments, capability information may be communicated via signaling or capability information may be provided to devices without a need for signaling. If information is available to other devices the information may be used for signaling or local decision making.

In some embodiments, a UE antenna panel may be a physical or logical antenna array including a set of antenna elements or antenna ports that share a common or a significant portion of a radio frequency (“RF”) chain (e.g., in-phase and/or quadrature (“I/Q”) modulator, analog to digital (“A/D”) converter, local oscillator, phase shift network). The UE antenna panel or UE panel may be a logical entity with physical UE antennas mapped to the logical entity. The mapping of physical UE antennas to the logical entity may be up to UE implementation. Communicating (e.g., receiving or transmitting) on at least a subset of antenna elements or antenna ports active for radiating energy (e.g., active elements) of an antenna panel may require biasing or powering on of an RF chain which results in current drain or power consumption in a UE associated with the antenna panel (e.g., including power amplifier and/or low noise amplifier (“LNA”) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In certain embodiments, depending on a UE's own implementation, a “UE panel” may have at least one of the following functionalities as an operational role of unit of antenna group to control its transmit (“TX”) beam independently, unit of antenna group to control its transmission power independently, and/or unit of antenna group to control its transmission timing independently. The “UE panel” may be transparent to a gNB. For certain conditions, a gNB or network may assume that a mapping between a UE's physical antennas to the logical entity “UE panel” may not be changed. For example, a condition may include until the next update or report from UE or include a duration of time over which the gNB assumes there will be no change to mapping. A UE may report its UE capability with respect to the “UE panel” to the gNB or network. The UE capability may include at least the number of “UE panels.” In one embodiment, a UE may support UL transmission from one beam within a panel. With multiple panels, more than one beam (e.g., one beam per panel) may be used for UL transmission. In another embodiment, more than one beam per panel may be supported and/or used for UL transmission.

In some embodiments, an antenna port may be defined such that a channel over which a symbol on the antenna port is conveyed may be inferred from the channel over which another symbol on the same antenna port is conveyed.

In certain embodiments, two antenna ports are said to be quasi co-located (“QCL”) if large-scale properties of a channel over which a symbol on one antenna port is conveyed may be inferred from the channel over which a symbol on another antenna port is conveyed. Large-scale properties may include one or more of delay spread, Doppler spread, Doppler shift, average gain, average delay, and/or spatial receive (“RX”) parameters. Two antenna ports may be quasi co-located with respect to a subset of the large-scale properties and different subset of large-scale properties may be indicated by a QCL Type. For example, a qcl-Type may take one of the following values: 1) ‘QCL-TypeA’: {Doppler shift, Doppler spread, average delay, delay spread}; 2) ‘QCL-TypeB’: {Doppler shift, Doppler spread}; 3) ‘QCL-TypeC’: {Doppler shift, average delay}; and 4) ‘QCL-TypeD’: {Spatial Rx parameter}. Other QCL-Types may be defined based on combination of one or large-scale properties.

In various embodiments, spatial RX parameters may include one or more of: angle of arrival (“AoA”), dominant AoA, average AoA, angular spread, power angular spectrum (“PAS”) of AoA, average angle of departure (“AoD”), PAS of AoD, transmit and/or receive channel correlation, transmit and/or receive beamforming, and/or spatial channel correlation.

In certain embodiments, QCL-TypeA, QCL-TypeB, and QCL-TypeC may be applicable for all carrier frequencies, but QCL-TypeD may be applicable only in higher carrier frequencies (e.g., mmWave, FR2, and beyond), where the UE may not be able to perform omni-directional transmission (e.g., the UE would need to form beams for directional transmission). For a QCL-TypeD between two reference signals A and B, the reference signal A is considered to be spatially co-located with reference signal B and the UE may assume that the reference signals A and B can be received with the same spatial filter (e.g., with the same RX beamforming weights).

In some embodiments, an “antenna port” may be a logical port that may correspond to a beam (e.g., resulting from beamforming) or may correspond to a physical antenna on a device. In certain embodiments, a physical antenna may map directly to a single antenna port in which an antenna port corresponds to an actual physical antenna. In various embodiments, a set of physical antennas, a subset of physical antennas, an antenna set, an antenna array, or an antenna sub-array may be mapped to one or more antenna ports after applying complex weights and/or a cyclic delay to the signal on each physical antenna. The physical antenna set may have antennas from a single module or panel or from multiple modules or panels. The weights may be fixed as in an antenna virtualization scheme, such as cyclic delay diversity (“CDD”). A procedure used to derive antenna ports from physical antennas may be specific to a device implementation and transparent to other devices.

In certain embodiments, a transmission configuration indicator (“TCI”) state (“TCI-state”) associated with a target transmission may indicate parameters for configuring a quasi-co-location relationship between the target transmission (e.g., target RS of demodulation (“DM”) reference signal (“RS”) (“DM-RS”) ports of the target transmission during a transmission occasion) and a source reference signal (e.g., synchronization signal block (“SSB”), CSI-RS, and/or SRS) with respect to quasi co-location type parameters indicated in a corresponding TCI state. The TCI describes which reference signals are used as a QCL source, and what QCL properties may be derived from each reference signal. A device may receive a configuration of a plurality of transmission configuration indicator states for a serving cell for transmissions on the serving cell. In some embodiments, a TCI state includes at least one source RS to provide a reference (e.g., UE assumption) for determining QCL and/or a spatial filter.

In some embodiments, spatial relation information associated with a target transmission may indicate a spatial setting between a target transmission and a reference RS (e.g., SSB, CSI-RS, and/or SRS). For example, a UE may transmit a target transmission with the same spatial domain filter used for receiving a reference RS (e.g., DL RS such as SSB and/or CSI-RS). In another example, a UE may transmit a target transmission with the same spatial domain transmission filter used for the transmission of a RS (e.g., UL RS such as SRS). A UE may receive a configuration of multiple spatial relation information configurations for a serving cell for transmissions on a serving cell.

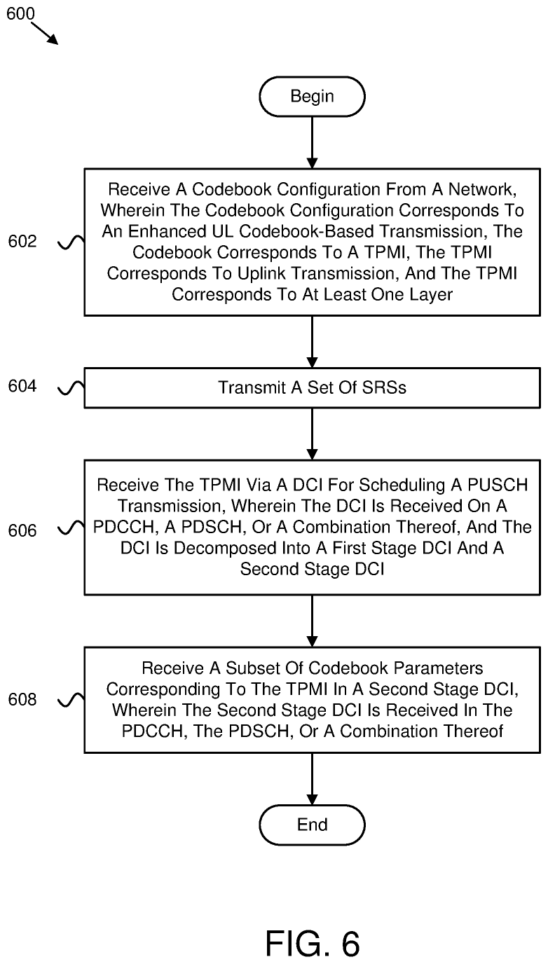

FIG. 6 is a flow chart diagram illustrating one embodiment of a method 600 for configuring a codebook corresponding to TPMI. In some embodiments, the method 600 is performed by an apparatus, such as the remote unit 102. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes receiving 602 a codebook configuration from a network. The codebook configuration corresponds to an enhanced UL codebook-based transmission, the codebook corresponds to a TPMI, the TPMI corresponds to uplink transmission, and the TPMI corresponds to at least one layer. In some embodiments, the method 600 includes transmitting 604 a set of SRSs. In certain embodiments, the method 600 includes receiving 606 the TPMI via a DCI for scheduling a PUSCH transmission. The DCI is received on a PDCCH, a PDSCH, or a combination thereof, and the DCI is decomposed into a first stage DCI and a second stage DCI. In various embodiments, the method 600 includes receiving 608 a subset of codebook parameters corresponding to the TPMI in a second stage DCI. The second stage DCI is received in the PDCCH, the PDSCH, or a combination thereof.

In certain embodiments, a bandwidth part of the PUSCH comprises a plurality of sub-bands, and different transmit precoders are applied to different sub-bands within the bandwidth part. In some embodiments, a sub-band is not configured if a higher-layer parameter corresponding to a precoder transform is configured. In various embodiments, the codebook comprises codebook parameters corresponding to a rank indicator, a set of spatial beams, a set of frequency domain basis indices, a set of coefficients for each layer corresponding to a distinct pair of a spatial beam of the set of spatial beams and a frequency-domain basis index of the set of frequency-domain basis indices, a set of one or more bitmaps for one or more layers corresponding to the indices of non-zero valued codebook coefficients, an index corresponding to a strongest coefficient for each layer, an indication of a total number of non-zero coefficients, or some combination thereof.

In one embodiment, the codebook parameters are partitioned based on a reporting method into: a first partition corresponding to codebook parameters reported via higher-layer parameters; a second partition corresponding to codebook parameters reported via DCI scheduling PUSCH carried on PDCCH; a third partition corresponding to codebook parameters reported via DCI scheduling PUSCH carried on PDSCH; a fourth partition corresponding to codebook parameters reported via MAC CE; or some combination thereof. In certain embodiments, the method 600 further comprises configuring reception of the codebook with up to two PMIs. In some embodiments, the method 600 further comprises configuring a TCI codepoint corresponding to two TCI states, wherein the two TCI states comprise QCL information corresponding to spatial relations for different DL RSs, and the DL RSs are included in spatial relation information of SRS corresponding to the set of SRSs.

In various embodiments, the method 600 further comprises configuring reception of the codebook with two SRS resource sets with a usage value that is set to indicate an enhanced codebook-based transmission. In one embodiment, the method 600 further comprises configuring reception of the codebook with an SRI that indicates multiple SRS resource IDs. In certain embodiments, the codebook configuration comprises a higher-layer parameter corresponding to a transmission configuration ‘txConfig’ in a PUSCH configuration IE that takes on one of at least three values corresponding to a non-codebook based transmission, a codebook based transmission, and an enhanced codebook based transmission.

In some embodiments, the codebook configuration comprises a first higher-layer parameter that indicates a codebook type in a PUSCH configuration IE, and a presence of the first higher-layer parameter is conditioned on a presence of a second higher-layer parameter corresponding to a transmission configuration ‘txConfig’ in a PUSCH configuration IE that is set to a codebook based transmission. In various embodiments, the DCI corresponds to a DCI format that includes at least one field corresponding to parameters of the codebook. In one embodiment, the codebook comprises a ‘precoding information and number of layers’ field that is: reserved; or padded with a number of bits having values equal to zero.

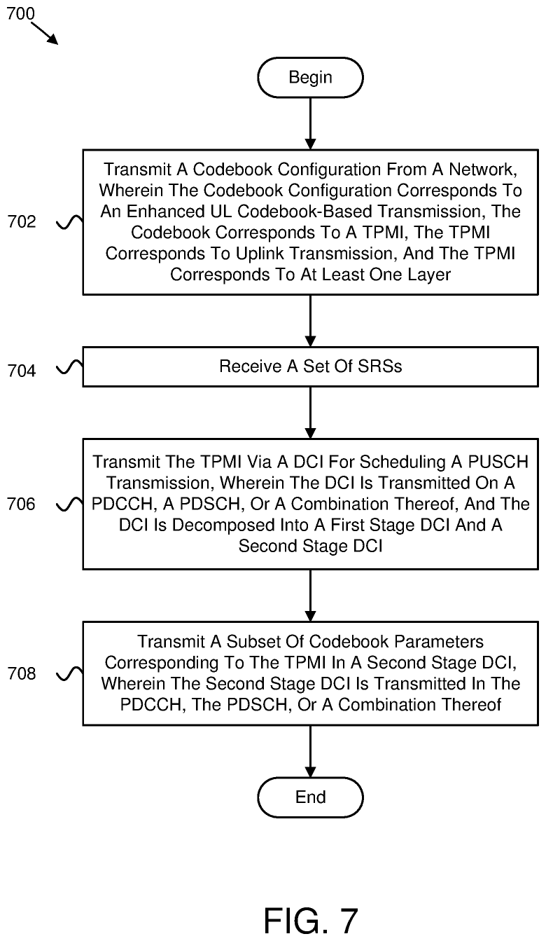

FIG. 7 is a flow chart diagram illustrating another embodiment of a method 700 for configuring a codebook corresponding to TPMI. In some embodiments, the method 700 is performed by an apparatus, such as the network unit 104. In certain embodiments, the method 700 may be performed by a processor executing program code, for example, a microcontroller, a microprocessor, a CPU, a GPU, an auxiliary processing unit, a FPGA, or the like.

In various embodiments, the method 700 includes transmitting 702 a codebook configuration from a network. The codebook configuration corresponds to an enhanced UL codebook-based transmission, the codebook corresponds to a TPMI, the TPMI corresponds to uplink transmission, and the TPMI corresponds to at least one layer. In some embodiments, the method 700 includes receiving 704 a set of SRSs. In certain embodiments, the method 700 includes transmitting 706 the TPMI via a DCI for scheduling a PUSCH transmission. The DCI is transmitted on a PDCCH, a PDSCH, or a combination thereof, and the DCI is decomposed into a first stage DCI and a second stage DCI. In various embodiments, the method 700 includes transmitting 708 a subset of codebook parameters corresponding to the TPMI in a second stage DCI. The second stage DCI is transmitted in the PDCCH, the PDSCH, or a combination thereof.

In certain embodiments, a bandwidth part of the PUSCH comprises a plurality of sub-bands, and different transmit precoders are applied to different sub-bands within the bandwidth part. In some embodiments, a sub-band is not configured if a higher-layer parameter corresponding to a precoder transform is configured. In various embodiments, the codebook comprises codebook parameters corresponding to a rank indicator, a set of spatial beams, a set of frequency domain basis indices, a set of coefficients for each layer corresponding to a distinct pair of a spatial beam of the set of spatial beams and a frequency-domain basis index of the set of frequency-domain basis indices, a set of one or more bitmaps for one or more layers corresponding to the indices of non-zero valued codebook coefficients, an index corresponding to a strongest coefficient for each layer, an indication of a total number of non-zero coefficients, or some combination thereof.

In one embodiment, the codebook parameters are partitioned based on a reporting method into: a first partition corresponding to codebook parameters reported via higher-layer parameters; a second partition corresponding to codebook parameters reported via DCI scheduling PUSCH carried on PDCCH; a third partition corresponding to codebook parameters reported via DCI scheduling PUSCH carried on PDSCH; a fourth partition corresponding to codebook parameters reported via MAC CE; or some combination thereof. In certain embodiments, the codebook configuration comprises a higher-layer parameter corresponding to a transmission configuration ‘txConfig’ in a PUSCH configuration IE that takes on one of at least three values corresponding to a non-codebook based transmission, a codebook based transmission, and an enhanced codebook based transmission. In some embodiments, the codebook configuration comprises a first higher-layer parameter that indicates a codebook type in a PUSCH configuration IE, and a presence of the first higher-layer parameter is conditioned on a presence of a second higher-layer parameter corresponding to a transmission configuration ‘txConfig’ in a PUSCH configuration IE that is set to a codebook based transmission.

In various embodiments, the DCI corresponds to a DCI format that includes at least one field corresponding to parameters of the codebook. In one embodiment, the codebook comprises a ‘precoding information and number of layers’ field that is: reserved; or padded with a number of bits having values equal to zero.

In one embodiment, an apparatus comprises: a receiver to receive a codebook configuration from a network, wherein the codebook configuration corresponds to an enhanced UL codebook-based transmission, the codebook corresponds to a TPMI, the TPMI corresponds to uplink transmission, and the TPMI corresponds to at least one layer; and a transmitter to transmit a set of SRSs, wherein the receiver further to: receive the TPMI via a DCI for scheduling a PUSCH transmission, wherein the DCI is received on a PDCCH, a PDSCH, or a combination thereof, and the DCI is decomposed into a first stage DCI and a second stage DCI; and receive a subset of codebook parameters corresponding to the TPMI in a second stage DCI, wherein the second stage DCI is received in the PDCCH, the PDSCH, or a combination thereof.

In certain embodiments, a bandwidth part of the PUSCH comprises a plurality of sub-bands, and different transmit precoders are applied to different sub-bands within the bandwidth part.

In some embodiments, a sub-band is not configured if a higher-layer parameter corresponding to a precoder transform is configured.

In various embodiments, the codebook comprises codebook parameters corresponding to a rank indicator, a set of spatial beams, a set of frequency domain basis indices, a set of coefficients for each layer corresponding to a distinct pair of a spatial beam of the set of spatial beams and a frequency-domain basis index of the set of frequency-domain basis indices, a set of one or more bitmaps for one or more layers corresponding to the indices of non-zero valued codebook coefficients, an index corresponding to a strongest coefficient for each layer, an indication of a total number of non-zero coefficients, or some combination thereof.

In one embodiment, the codebook parameters are partitioned based on a reporting method into: a first partition corresponding to codebook parameters reported via higher-layer parameters; a second partition corresponding to codebook parameters reported via DCI scheduling PUSCH carried on PDCCH; a third partition corresponding to codebook parameters reported via DCI scheduling PUSCH carried on PDSCH; a fourth partition corresponding to codebook parameters reported via MAC CE; or some combination thereof.

In certain embodiments, the apparatus further comprises a processor to configure reception of the codebook with up to two PMIs.

In some embodiments, the processor further to configure a TCI codepoint corresponding to two TCI states, wherein the two TCI states comprise QCL information corresponding to spatial relations for different DL RSs, and the DL RSs are included in spatial relation information of SRS corresponding to the set of SRSs.

In various embodiments, the processor further to configure reception of the codebook with two SRS resource sets with a usage value that is set to indicate an enhanced codebook-based transmission.

In one embodiment, the processor further to configure reception of the codebook with an SRI that indicates multiple SRS resource IDs.

In certain embodiments, the codebook configuration comprises a higher-layer parameter corresponding to a transmission configuration ‘txConfig’ in a PUSCH configuration IE that takes on one of at least three values corresponding to a non-codebook based transmission, a codebook based transmission, and an enhanced codebook based transmission.

In some embodiments, the codebook configuration comprises a first higher-layer parameter that indicates a codebook type in a PUSCH configuration IE, and a presence of the first higher-layer parameter is conditioned on a presence of a second higher-layer parameter corresponding to a transmission configuration ‘txConfig’ in a PUSCH configuration IE that is set to a codebook based transmission.

In various embodiments, the DCI corresponds to a DCI format that includes at least one field corresponding to parameters of the codebook.

In one embodiment, the codebook comprises a ‘precoding information and number of layers’ field that is: reserved; or padded with a number of bits having values equal to zero.

In one embodiment, a method at a UE, the method comprises: receiving a codebook configuration from a network, wherein the codebook configuration corresponds to an enhanced UL codebook-based transmission, the codebook corresponds to a TPMI, the TPMI corresponds to uplink transmission, and the TPMI corresponds to at least one layer; transmitting a set of SRSs; receiving the TPMI via a DCI for scheduling a PUSCH transmission, wherein the DCI is received on a PDCCH, a PDSCH, or a combination thereof, and the DCI is decomposed into a first stage DCI and a second stage DCI; and receiving a subset of codebook parameters corresponding to the TPMI in a second stage DCI, wherein the second stage DCI is received in the PDCCH, the PDSCH, or a combination thereof.

In certain embodiments, a bandwidth part of the PUSCH comprises a plurality of sub-bands, and different transmit precoders are applied to different sub-bands within the bandwidth part.

In some embodiments, a sub-band is not configured if a higher-layer parameter corresponding to a precoder transform is configured.

In various embodiments, the codebook comprises codebook parameters corresponding to a rank indicator, a set of spatial beams, a set of frequency domain basis indices, a set of coefficients for each layer corresponding to a distinct pair of a spatial beam of the set of spatial beams and a frequency-domain basis index of the set of frequency-domain basis indices, a set of one or more bitmaps for one or more layers corresponding to the indices of non-zero valued codebook coefficients, an index corresponding to a strongest coefficient for each layer, an indication of a total number of non-zero coefficients, or some combination thereof.

In one embodiment, the codebook parameters are partitioned based on a reporting method into: a first partition corresponding to codebook parameters reported via higher-layer parameters; a second partition corresponding to codebook parameters reported via DCI scheduling PUSCH carried on PDCCH; a third partition corresponding to codebook parameters reported via DCI scheduling PUSCH carried on PDSCH; a fourth partition corresponding to codebook parameters reported via MAC CE; or some combination thereof.

In certain embodiments, the method further comprises configuring reception of the codebook with up to two PMIs.

In some embodiments, the method further comprises configuring a TCI codepoint corresponding to two TCI states, wherein the two TCI states comprise QCL information corresponding to spatial relations for different DL RSs, and the DL RSs are included in spatial relation information of SRS corresponding to the set of SRSs.

In various embodiments, the method further comprises configuring reception of the codebook with two SRS resource sets with a usage value that is set to indicate an enhanced codebook-based transmission.

In one embodiment, the method further comprises configuring reception of the codebook with an SRI that indicates multiple SRS resource IDs.

In certain embodiments, the codebook configuration comprises a higher-layer parameter corresponding to a transmission configuration ‘txConfig’ in a PUSCH configuration IE that takes on one of at least three values corresponding to a non-codebook based transmission, a codebook based transmission, and an enhanced codebook based transmission.

In some embodiments, the codebook configuration comprises a first higher-layer parameter that indicates a codebook type in a PUSCH configuration IE, and a presence of the first higher-layer parameter is conditioned on a presence of a second higher-layer parameter corresponding to a transmission configuration ‘txConfig’ in a PUSCH configuration IE that is set to a codebook based transmission.

In various embodiments, the DCI corresponds to a DCI format that includes at least one field corresponding to parameters of the codebook.

In one embodiment, the codebook comprises a ‘precoding information and number of layers’ field that is: reserved; or padded with a number of bits having values equal to zero.

In one embodiment, an apparatus comprises: a transmitter to transmit a codebook configuration from a network, wherein the codebook configuration corresponds to an enhanced UL codebook-based transmission, the codebook corresponds to a TPMI, the TPMI corresponds to uplink transmission, and the TPMI corresponds to at least one layer; and a receiver to receive a set of SRSs, wherein the transmitter further to: transmit the TPMI via a DCI for scheduling a PUSCH transmission, wherein the DCI is transmitted on a PDCCH, a PDSCH, or a combination thereof, and the DCI is decomposed into a first stage DCI and a second stage DCI; and transmit a subset of codebook parameters corresponding to the TPMI in a second stage DCI, wherein the second stage DCI is transmitted in the PDCCH, the PDSCH, or a combination thereof.

In certain embodiments, a bandwidth part of the PUSCH comprises a plurality of sub-bands, and different transmit precoders are applied to different sub-bands within the bandwidth part.

In some embodiments, a sub-band is not configured if a higher-layer parameter corresponding to a precoder transform is configured.

In various embodiments, the codebook comprises codebook parameters corresponding to a rank indicator, a set of spatial beams, a set of frequency domain basis indices, a set of coefficients for each layer corresponding to a distinct pair of a spatial beam of the set of spatial beams and a frequency-domain basis index of the set of frequency-domain basis indices, a set of one or more bitmaps for one or more layers corresponding to the indices of non-zero valued codebook coefficients, an index corresponding to a strongest coefficient for each layer, an indication of a total number of non-zero coefficients, or some combination thereof.

In one embodiment, the codebook parameters are partitioned based on a reporting method into: a first partition corresponding to codebook parameters reported via higher-layer parameters; a second partition corresponding to codebook parameters reported via DCI scheduling PUSCH carried on PDCCH; a third partition corresponding to codebook parameters reported via DCI scheduling PUSCH carried on PDSCH; a fourth partition corresponding to codebook parameters reported via MAC CE; or some combination thereof.

In certain embodiments, the codebook configuration comprises a higher-layer parameter corresponding to a transmission configuration ‘txConfig’ in a PUSCH configuration IE that takes on one of at least three values corresponding to a non-codebook based transmission, a codebook based transmission, and an enhanced codebook based transmission.

In some embodiments, the codebook configuration comprises a first higher-layer parameter that indicates a codebook type in a PUSCH configuration IE, and a presence of the first higher-layer parameter is conditioned on a presence of a second higher-layer parameter corresponding to a transmission configuration ‘txConfig’ in a PUSCH configuration IE that is set to a codebook based transmission.

In various embodiments, the DCI corresponds to a DCI format that includes at least one field corresponding to parameters of the codebook.

In one embodiment, the codebook comprises a ‘precoding information and number of layers’ field that is: reserved; or padded with a number of bits having values equal to zero.

In one embodiment, a method at a network device, the method comprises: transmitting a codebook configuration from a network, wherein the codebook configuration corresponds to an enhanced UL codebook-based transmission, the codebook corresponds to a TPMI, the TPMI corresponds to uplink transmission, and the TPMI corresponds to at least one layer; receiving a set of SRSs; transmitting the TPMI via a DCI for scheduling a PUSCH transmission, wherein the DCI is transmitted on a PDCCH, a PDSCH, or a combination thereof, and the DCI is decomposed into a first stage DCI and a second stage DCI; and transmitting a subset of codebook parameters corresponding to the TPMI in a second stage DCI, wherein the second stage DCI is transmitted in the PDCCH, the PDSCH, or a combination thereof.

In certain embodiments, a bandwidth part of the PUSCH comprises a plurality of sub-bands, and different transmit precoders are applied to different sub-bands within the bandwidth part.

In some embodiments, a sub-band is not configured if a higher-layer parameter corresponding to a precoder transform is configured.

In various embodiments, the codebook comprises codebook parameters corresponding to a rank indicator, a set of spatial beams, a set of frequency domain basis indices, a set of coefficients for each layer corresponding to a distinct pair of a spatial beam of the set of spatial beams and a frequency-domain basis index of the set of frequency-domain basis indices, a set of one or more bitmaps for one or more layers corresponding to the indices of non-zero valued codebook coefficients, an index corresponding to a strongest coefficient for each layer, an indication of a total number of non-zero coefficients, or some combination thereof.

In one embodiment, the codebook parameters are partitioned based on a reporting method into: a first partition corresponding to codebook parameters reported via higher-layer parameters; a second partition corresponding to codebook parameters reported via DCI scheduling PUSCH carried on PDCCH; a third partition corresponding to codebook parameters reported via DCI scheduling PUSCH carried on PDSCH; a fourth partition corresponding to codebook parameters reported via MAC CE; or some combination thereof.

In certain embodiments, the codebook configuration comprises a higher-layer parameter corresponding to a transmission configuration ‘txConfig’ in a PUSCH configuration IE that takes on one of at least three values corresponding to a non-codebook based transmission, a codebook based transmission, and an enhanced codebook based transmission.

In some embodiments, the codebook configuration comprises a first higher-layer parameter that indicates a codebook type in a PUSCH configuration IE, and a presence of the first higher-layer parameter is conditioned on a presence of a second higher-layer parameter corresponding to a transmission configuration ‘txConfig’ in a PUSCH configuration IE that is set to a codebook based transmission.

In various embodiments, the DCI corresponds to a DCI format that includes at least one field corresponding to parameters of the codebook.

In one embodiment, the codebook comprises a ‘precoding information and number of layers’ field that is: reserved; or padded with a number of bits having values equal to zero.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive a codebook configuration from a network, wherein the codebook configuration corresponds to an enhanced uplink (UL) codebook-based transmission, the codebook corresponds to a transmit precoding matrix information (TPMI), the TPMI corresponds to uplink transmission, and the TPMI corresponds to at least one layer;
transmit a set of sounding reference signals (SRSs);
receive the TPMI via a downlink control information (DCI) for scheduling a physical uplink shared channel (PUSCH) transmission, wherein the DCI is received on a physical downlink control channel (PDCCH), a physical downlink shared channel (PDSCH), or a combination thereof, and the DCI is decomposed into a first stage DCI and a second stage DCI; and
receive a subset of codebook parameters corresponding to the TPMI in a second stage DCI, wherein the second stage DCI is received in the PDCCH, the PDSCH, or a combination thereof.

2. The UE of claim 1, wherein a bandwidth part of the PUSCH comprises a plurality of sub-bands, and different transmit precoders are applied to different sub-bands within the bandwidth part.

3. The UE of claim 2, wherein a sub-band is not configured if a higher-layer parameter corresponding to a precoder transform is configured.

4. The UE of claim 1, wherein the codebook comprises codebook parameters corresponding to a rank indicator, a set of spatial beams, a set of frequency domain basis indices, a set of coefficients for each layer corresponding to a distinct pair of a spatial beam of the set of spatial beams and a frequency-domain basis index of the set of frequency-domain basis indices, a set of one or more bitmaps for one or more layers corresponding to the indices of non-zero valued codebook coefficients, an index corresponding to a strongest coefficient for each layer, an indication of a total number of non-zero coefficients, or some a combination thereof.

5. The UE of claim 4, wherein the codebook parameters are partitioned based on a reporting method into:
a first partition corresponding to codebook parameters reported via higher-layer parameters;
a second partition corresponding to codebook parameters reported via DCI scheduling PUSCH carried on PDCCH;
a third partition corresponding to codebook parameters reported via DCI scheduling PUSCH carried on PDSCH;
a fourth partition corresponding to codebook parameters reported via MAC CE;
or a combination thereof.

6. The UE of claim 5, wherein the at least one processor is configured to cause the UE to configure reception of the codebook with up to two precoder matrix indicators (PMIs).

7. The UE of claim 6, wherein the at least one processor is configured to cause the UE to configure a transmission configuration indicator (TCI) codepoint corresponding to two TCI states, wherein the two TCI states comprise quasi-co-location (QCL) information corresponding to spatial relations for different downlink (DL) reference signals (RSs), and the DL RSs are included in spatial relation information of SRS corresponding to the set of SRSs.

8. The UE of claim 6, wherein the at least one processor is configured to cause the UE further to configure reception of the codebook with two SRS resource sets with a usage value that is set to indicate an enhanced codebook-based transmission.

9. The UE of claim 6, wherein the at least one processor is configured to cause the UE to configure reception of the codebook with an SRS resource indicator (SRI) that indicates multiple SRS resource identifiers (IDs).

10. The UE of claim 1, wherein the codebook configuration comprises a higher-layer parameter corresponding to a transmission configuration ‘txConfig’ in a PUSCH configuration information element (IE) that takes on one of at least three values corresponding to a non-codebook based transmission, a codebook based transmission, and an enhanced codebook based transmission.

11. The UE of claim 1, wherein the codebook configuration comprises a first higher-layer parameter that indicates a codebook type in a PUSCH configuration IE, and a presence of the first higher-layer parameter is conditioned on a presence of a second higher-layer parameter corresponding to a transmission configuration ‘txConfig’ in a PUSCH configuration IE that is set to a codebook based transmission.

12. The UE of claim 1, wherein the DCI corresponds to a DCI format that includes at least one field corresponding to parameters of the codebook.

13. The UE of claim 1, wherein the codebook comprises a ‘precoding information and number of layers’ field that is:
reserved; or
padded with a number of bits having values equal to zero.

14. A method at a user equipment (UE), the method comprising:
receiving a codebook configuration from a network, wherein the codebook configuration corresponds to an enhanced uplink (UL) codebook-based transmission, the codebook corresponds to a transmit precoding matrix information (TPMI), the TPMI corresponds to uplink transmission, and the TPMI corresponds to at least one layer;
transmitting a set of sounding reference signals (SRSs);
receiving the TPMI via a downlink control information (DCI) for scheduling a physical uplink shared channel (PUSCH) transmission, wherein the DCI is received on a physical downlink control channel (PDCCH), a physical downlink shared channel (PDSCH), or a combination thereof, and the DCI is decomposed into a first stage DCI and a second stage DCI; and
receiving a subset of codebook parameters corresponding to the TPMI in a second stage DCI, wherein the second stage DCI is received in the PDCCH, the PDSCH, or a combination thereof.

15. An apparatus for performing a network function, the apparatus comprising:
at least one memory; and
at least one processor coupled with the at least one memory and configured to cause the apparatus to:
transmit a codebook configuration from a network, wherein the codebook configuration corresponds to an enhanced uplink (UL) codebook-based transmission, the codebook corresponds to a transmit precoding matrix information (TPMI), the TPMI corresponds to uplink transmission, and the TPMI corresponds to at least one layer;
receive a set of sounding reference signals (SRSs);
transmit the TPMI via a downlink control information (DCI) for scheduling a physical uplink shared channel (PUSCH) transmission, wherein the DCI is transmitted on a physical downlink control channel (PDCCH), a physical downlink shared channel (PDSCH), or a combination thereof, and the DCI is decomposed into a first stage DCI and a second stage DCI; and
transmit a subset of codebook parameters corresponding to the TPMI in a second stage DCI, wherein the second stage DCI is transmitted in the PDCCH, the PDSCH, or a combination thereof.

16. A processor for wireless communication, comprising:
at least one controller coupled with at least one memory and configured to cause the processor to:
receive a codebook configuration from a network, wherein the codebook configuration corresponds to an enhanced uplink (UL) codebook-based transmission, the codebook corresponds to a transmit precoding matrix information (TPMI), the TPMI corresponds to uplink transmission, and the TPMI corresponds to at least one layer;
transmit a set of sounding reference signals (SRSs);
receive the TPMI via a downlink control information (DCI) for scheduling a physical uplink shared channel (PUSCH) transmission, wherein the DCI is received on a physical downlink control channel (PDCCH), a physical downlink shared channel (PDSCH), or a combination thereof, and the DCI is decomposed into a first stage DCI and a second stage DCI; and
receive a subset of codebook parameters corresponding to the TPMI in a second stage DCI, wherein the second stage DCI is received in the PDCCH, the PDSCH, or a combination thereof.

17. The processor of claim 16, wherein a bandwidth part of the PUSCH comprises a plurality of sub-bands, and different transmit precoders are applied to different sub-bands within the bandwidth part.

18. The processor of claim 17, wherein a sub-band is not configured if a higher-layer parameter corresponding to a precoder transform is configured.

19. The processor of claim 16, wherein the codebook comprises codebook parameters corresponding to a rank indicator, a set of spatial beams, a set of frequency domain basis indices, a set of coefficients for each layer corresponding to a distinct pair of a spatial beam of the set of spatial beams and a frequency-domain basis index of the set of frequency-domain basis indices, a set of one or more bitmaps for one or more layers corresponding to the indices of non-zero valued codebook coefficients, an index corresponding to a strongest coefficient for each layer, an indication of a total number of non-zero coefficients, or a combination thereof.

20. The processor of claim 19, wherein the codebook parameters are partitioned based on a reporting method into:
a first partition corresponding to codebook parameters reported via higher-layer parameters;
a second partition corresponding to codebook parameters reported via DCI scheduling PUSCH carried on PDCCH;
a third partition corresponding to codebook parameters reported via DCI scheduling PUSCH carried on PDSCH;
a fourth partition corresponding to codebook parameters reported via MAC CE;
or a combination thereof.
